(19) United States
(12) Patent Application Publication
(10) Pub. No.: US 2016/0354732 A1
(43) Pub. Date: Dec. 8, 2016

(54) BEVERAGE AERATOR

(71) Applicant: SPONTI LIMITED, Sheung Wan (HK)

(72) Inventor: ALBERT MOK, Sheung Wan (HK)

(73) Assignee: SPONTI LIMITED, Sheung Wan (HK)

(21) Appl. No.: 14/731,735

(22) Filed: Jun. 5, 2015

(51) Int. Cl. B01F 3/04; B01F 5/04

(52) U.S. Cl. CPC B01F 3/04787; B01F 5/0413

(57) ABSTRACT

A liquid aerator including a first conduit for liquid communication therethrough, a second conduit for air communication therethrough, and, a third conduit configured for air communication between the first and second conduits; the first conduit including an internal shape configuration for generating a first pressure condition therein as liquid flows therethrough wherein air in the third conduit is drawn in to the first conduit in response to the first pressure condition generated in the first conduit, and, the second conduit including an internal shape configuration for generating a second pressure condition therein as air flows therethrough wherein air in the second conduit is forced in to the third conduit in response to the second pressure condition generated in the second conduit, whereby air flowing through the second conduit is transferred via the third conduit in to contact with the liquid flowing through the first conduit to aerate the liquid.

### TECHNICAL FIELD

The present invention relates to aerators for beverages such as wine and spirits.

### BACKGROUND OF THE INVENTION

It is common for many wine drinkers to let a recently opened bottle of wine to “breathe” by aerating the wine with oxygen in order to soften the wine's tannins, to reduce acidity, and to expose aromas which are released as the wine interacts with the oxygen.

One method that has been used for aerating wine has involved pouring the wine into a decanter which exposes a greater surface area of the wine to ambient air to aerate the wine over time. The decanter may also be swirled around to further encourage interaction of oxygen in the ambient air with the wine in the decanter. Whilst this process may assist in aerating the wine, there are several disadvantages associated with it. Firstly, the wine cannot be poured directly in the wine glass and requires an intermediate step of pouring the wine into the decanter before the wine reaches the wine glass. Secondly, the entire bottle of wine is exposed to aeration with the level of aeration being determined by the time the wine is allowed to decant. Should the wine not all be consumed at the best point in time, the remaining wine would continue to decant and aerate. If the wine is decanted too quickly the wine may not have sufficient aeration time, and should the wine be over-aerated in the decanter for too long, it is not possible to reverse the process.

Certain existing aerator devices take advantage of the Venturi effect to accelerate and enhance the exposure of wine to oxygen in the air as the wine is being poured through a Venturi tube. This is achieved by virtue of the internal shape configuration of the Venturi tube which is configured to generate a region of relatively low pressure high velocity which “pulls” in ambient air via an air feed conduit to mix with wine passing through the Venturi tube. The Venturi effect may be further understood by reference to FIGS. 1 and 2, and the equation below, from which it can be seen that as the pressure differential between P₁ and P₂ increases (or as the ratio of diameters A₁/A₂ within the Venturi tube increases), a higher velocity V₂ in the smaller diameter area A₂ of the Venturi tube is produced which increases the amount of ambient air that is able to be “pulled” into the Venturi tube.

$${p}_{1} - {p}_{2} = \frac{p}{2} ( {V}_{2}^{2} - {V}_{1}^{2} )$$

Where:
P₁ is the larger pressure from the larger diameter tube
P₂ is the smaller pressure from the smaller diameter tube
V₂ is the faster fluid velocity where the pipe is narrower
V₁ is the slower fluid velocity where the pipe is wider
p is the density of the fluid
A₁ is the diameter of the larger tube
A₂ is the diameter of the smaller tube

Certain Venturi tube based aerator devices may take the form of an “in-bottle” type aerator which is fitted to the opening of the wine bottle and which simultaneously serves as both a pourer and an aerator. Such devices are advantageous in that this eliminates the need for an intermediate aeration step (as when using a decanter) and the wine may be poured straight in to the wine glass as it is being aerated. However, the aeration ability of such in-bottle aerators tends to be limited by the size constraints due to the aerator having to be fitted in the opening of the wine bottle.

Other Venturi tube based aerator devices may take the form of “hand-held” aerators which tend to provide greater aeration ability than in-bottle type aerators due to there being no constraints upon the size and dimensions of the hand-held device so as to enhance the Venturi effect. However, the use of a hand-held aerator is also inconvenient in that it must be held in one hand as wine is being poured in to it with the other hand, or, additional equipment such as a stand must be employed to support the hand-held aerator as wine is being poured in to it. In either case, this does not lend itself well to use particularly in a busy service environment.

### SUMMARY OF THE INVENTION

The present invention seeks to alleviate at least one of the above-described problems.

The present invention may involve several broad forms. Embodiments of the present invention may include one or any combination of the different broad forms herein described.

In a first broad form the present invention provides a liquid aeration device including:

a first conduit for providing liquid communication between a first end and a second end of the first conduit;

a second conduit for providing air communication between a first end and a second end of the second conduit;

a third conduit being configured for providing air communication therethrough between the first conduit and the second conduit;

the first conduit including an internal shape configuration adapted for generating a first pressure condition therein as the liquid flows therethrough wherein air in the third conduit is able to be drawn in to the first conduit in response to the first pressure condition being generated in the first conduit, and, the second conduit including an internal shape configuration adapted for generating a second pressure condition therein as the air flows therethrough wherein air in the second conduit is able to be forced in to the third conduit in response to the second pressure condition being generated in the second conduit, whereby at least a volume of air flowing through the second conduit is able to be transferred via the third conduit in to contact with the liquid flowing through the first conduit to aerate the liquid.

Preferably, the first conduit may include a first Venturi tube having an internal shape configuration adapted for generating the first pressure condition in the first conduit.

Preferably, the second conduit may include a second Venturi tube having an internal shape configuration adapted for generating the second pressure condition in the second conduit.

Preferably, the first conduit may be configured for attachment to a liquid-containing vessel wherein the first conduit is positioned to allow the liquid in the vessel to be poured from the opening of the vessel into the first conduit via an opening in the first end of the conduit and outwardly of the first conduit via an opening in the second end of the first conduit.

Preferably, the second conduit may be configured for attachment to a liquid-containing vessel wherein the second conduit is positioned to allow air to flow into the liquid containing vessel via the second conduit whereby the air is able to fill the vessel in response to the liquid being poured from the opening of the vessel.

Preferably, the first conduit and the second conduit may be integrally formed in a pourer that is releasably attachable to the vessel to allow pouring of the liquid from the vessel.

Preferably, the present invention may include an occlusion device configured for regulating flow of air along the third conduit from the second conduit towards the first conduit.

Preferably, the occlusion device may include a throttle valve assembly.

Preferably, the throttle valve assembly may include a valve body movable relative to a valve seat so as to control and regulate air flow therebetween, wherein the valve body includes an occlusion surface and the valve seat includes a seating surface which define an annular airflow passage therebetween, whereby:

(i) upon movement of the valve body towards the valve seat, the annular airflow passage is reduced in area so as to reduce airflow; and
(ii) a centroid of the annular airflow passage remains coaxial with a longitudinal axis in a direction of the movement of the valve body towards the valve seat.

Preferably, the occlusion surface and the seating surface may be annular about the longitudinal axis and are inclined radially outwardly in a direction from the valve seat towards the valve body.

Preferably, the valve body may include a conical configuration.

Preferably, the present invention may include a threaded adjustment dial configured for controlling movement of the valve body relative to the valve seat between at least a closed configuration in which airflow through the annular airflow passage is blocked, and, an opened configuration in which airflow through the annular airflow passage is maximized.

Preferably, the throttle valve assembly may include a valve body movable relative to a valve seat so as to control and regulate air flow therebetween, wherein the valve body includes an occlusion surface and the valve seat includes a seating surface which define an annular airflow passage therebetween, whereby:

(i) upon movement of the valve body towards the valve seat, the annular airflow passage is reduced in area so as to reduce airflow; and
(ii) a centroid of the annular airflow passage remains coaxial with a longitudinal axis in a direction of the movement of the valve body towards the valve seat.

Preferably, the occlusion surface and the seating surface may be annular about the longitudinal axis and are inclined radially outwardly in a direction from the valve seat towards the valve body.

Preferably, the valve body may include a conical-shaped surface.

Preferably, the present invention may include a threaded adjustment dial configured for controlling movement of the valve body relative to the valve seat between at least a closed configuration in which airflow through the annular airflow passage is blocked, and, an opened configuration in which airflow through the annular airflow passage is maximized.

In a further broad form, the present invention provides a beverage pourer for pouring a beverage from a bottle, the beverage pourer including:

a hollow pourer body having an opening disposed at a first end and a spout at a second end, the hollow pourer body including a liquid pour conduit and an air intake conduit extending therethrough, and an air feed conduit configured for providing air communication from the air intake conduit towards the liquid pour conduit;

the liquid pour conduit having a first end positioned adjacent the first end of the hollow pourer body which is configured for positioning inside of the opening of the bottle, and, a second end of the liquid pour conduit being positioned adjacent the spout so as to allow the beverage in the bottle to be poured out of the bottle via the liquid pour conduit and spout;

the air intake conduit having a first end positioned adjacent the first end of the hollow pourer body which is configured for positioning inside of the opening of the bottle, and, a second end of the air intake conduit being configured for positioning to allow air from outside of the bottle to flow into the bottle via the air intake conduit in response to the beverage being poured out of the bottle via the liquid pour conduit;

the liquid pour conduit including an internal shape configuration adapted for generating a first pressure condition therein as the beverage flows therethrough wherein air in the adjoining air feed conduit is able to be drawn in to the liquid pour conduit in response to the first pressure condition being generated in the liquid pour conduit, and, the air intake conduit including an internal shape configuration adapted for generating a second pressure condition therein as the air flows therethrough wherein air in the air intake conduit is able to be forced in to the adjoining air feed conduit in response to the second pressure condition being generated in the air intake conduit, whereby at least a volume of air flowing through the air intake conduit is able to be transferred via the air feed conduit in to contact with the beverage flowing through the liquid pour conduit to aerate the beverage.

Preferably, the present invention may include an attachment member for releasably attaching the beverage pourer to the bottle. Preferably, the attachment member may include a collar configured for releasable attachment around a neck of the bottle having the opening disposed thereon, whereby when attached, the first end of the liquid pour conduit is positioned inside of the bottle opening and the second end of the liquid pour conduit is positioned outside of the bottle opening adjacent the spout, and, the first end of the air intake conduit is positioned inside of the bottle opening and the second end of the air intake conduit is configured for positioning to allow air from outside of the bottle opening to flow into the bottle via the air intake conduit.

Preferably, the present invention may include an occlusion device for regulating flow of air along the air feed conduit from the air intake conduit towards the liquid pour conduit.

Preferably, the occlusion device may include a throttle valve assembly.

Preferably, the throttle valve assembly may include a valve body movable relative to a valve seat so as to control and regulate air flow therebetween, wherein the valve body includes an occlusion surface and the valve seat includes a seating surface which define an annular airflow passage therebetween, whereby:

(i) upon movement of the valve body towards the valve seat, the annular airflow passage is reduced in area so as to reduce airflow; and
(ii) a centroid of the annular airflow passage remains coaxial with a longitudinal axis in a direction of the movement of the valve body towards the valve seat.

Preferably, the occlusion surface and the seating surface may be annular about the longitudinal axis and are inclined radially outwardly in a direction from the valve seat towards the valve body.

Preferably, the valve body may include a conical configuration.

Preferably, the present invention may include a threaded adjustment dial configured for controlling movement of the valve body relative to the valve seat between at least a closed configuration in which airflow through the annular airflow passage is blocked, and, an opened configuration in which airflow through the annular airflow passage is maximized.

Typically, in certain embodiments, the present any one of the broad forms of the present invention may include a depressible wall member in a wall of the pourer, wherein when depressed the depressible wall member is positioned to at partially occlude flow of air from an air intake conduit of the pourer to a liquid pour conduit of the pourer via a air feed conduit. Typically the depressible wall member may include an elastically deformable material.

### BRIEF DESCRIPTION OF THE DRAWINGS

The present invention will become more fully understood from the following detailed description of a preferred but non-limiting embodiment thereof, described in connection with the accompanying drawings, wherein:

FIG. 1 shows an existing system used to aerate a liquid;

FIG. 2 shows an abstract representation of the relationship between physical dimensions of a Venturi tube, pressure and volume of a liquid flowing therethrough to achieve a Venturi effect;

FIG. 3 shows a magnified schematic view of a first embodiment of the present invention;

FIG. 4 shows a schematic view of the first embodiment of the present invention fitted to an opening of a liquid-containing bottle;

FIG. 5 shows a schematic view of a second embodiment of the present invention including a throttle valve assembly for controllably regulating airflow used for aeration of the liquid, the second embodiment being shown fitted to an opening of a liquid-containing bottle;

FIG. 6 shows a front perspective view of the second embodiment of the present invention;

FIG. 7 shows a left-side perspective view of the second embodiment of the present invention;

FIG. 8 shows a top view of the second embodiment of the present invention;

FIG. 9 shows a bottom view of the second embodiment of the present invention;

FIG. 10 shows a rear view of the second embodiment of the present invention;

FIG. 11 shows a left-side view of the second embodiment of the present invention;

FIG. 12 shows a front view of the second embodiment of the present invention;

FIG. 13 shows a front view of the second embodiment of the present invention with indicia representing different operating positions of the throttle valve assembly;

FIG. 14 shows a left-side cross-sectional view of the second embodiment of the present invention;

FIGS. 15A-15D show a front view, a left-side view, a magnified view of the throttle valve assembly, and a cross-sectional view of the throttle valve assembly across the sectional line “A” respectively, when the throttle valve assembly is arranged in a fully-closed configuration;

FIGS. 16A-16D show a front view, a left-side view, a magnified view of the throttle valve assembly, and a cross-sectional view of the throttle valve assembly across the sectional line “A” respectively, when the throttle valve assembly is arranged in a first partially-opened configuration;

FIGS. 17A-17D show a front view, a left-side view, a magnified view of the throttle valve assembly, and a cross-sectional view of the throttle valve assembly across the sectional line “A” respectively, when the throttle valve assembly is arranged in a second partially-opened configuration;

FIGS. 18A-18D show a front view, a left-side view, a magnified view of the throttle valve assembly, and a cross-sectional view of the throttle valve assembly across the sectional line “A” respectively, when the throttle valve assembly is arranged in a third partially-opened configuration; and

FIGS. 19A-19D show a front view, a left-side view, a magnified view of the throttle valve assembly, and a cross-sectional view of the throttle valve assembly across the sectional line “A” respectively, when the throttle valve assembly is arranged in a fully-opened configuration.

FIG. 20 shows a front perspective view of a third embodiment of the present invention comprising a beverage aerator with a non-adjustable aeration arrangement and the liquid pour spout comprising a tubular-shaped spout and drip collector surface;

FIG. 21 shows a rear perspective view of the third embodiment;

FIG. 22 shows a top view of the third embodiment;

FIG. 23 shows a bottom view of the third embodiment;

FIG. 24 shows a rear view of the third embodiment;

FIG. 25 shows a left-side view of the third embodiment;

FIG. 26 shows a front view of the third embodiment;

FIG. 27 shows a left-side cross-sectional view of the third embodiment;

FIG. 28 shows a front perspective view of a fourth embodiment of the present invention comprising a beverage aerator with an adjustable aeration arrangement and the liquid pour spout comprising a tubular-shaped spout and drip collector surface;

FIG. 29 shows a rear perspective view of the fourth embodiment;

FIG. 30 shows a top view of the fourth embodiment;

FIG. 31 shows a bottom view of the fourth embodiment;

FIG. 32 shows a rear view of the fourth embodiment;

FIG. 33 shows a left-side view of the fourth embodiment;

FIG. 34 shows a front view of the fourth embodiment;

FIG. 35 shows a left-side cross-sectional view of the fourth embodiment;

FIG. 36 shows a beverage of relatively high viscosity being poured from a flared spout of a beverage pourer producing a relatively dispersed and uncontrolled stream being poured;

FIG. 37 shows a beverage of relatively high viscosity being poured from a tubular-shaped spout in accordance with the third and fourth embodiments of the present invention wherein the stream is relatively focused and controlled as it is being poured from the tubular-shaped spout.

FIG. 38A shows a further embodiment of the present invention having an occlusion device comprising a depressible covering operable to block flow of air into the liquid pour conduit from air intake conduit when the depressible covering is depressed.

FIG. 38B shows a magnified view of the depressible covering of the embodiment shown in FIG. 38A in a depressed position whereby passage of air into the liquid pour tube is occluded.

FIG. 39A shows a further embodiment of the present invention having a constricted region disposed in the air intake conduit;

FIG. 39B shows a magnified view of the constricted region in the air intake conduit of the embodiment shown in FIG. 39A.

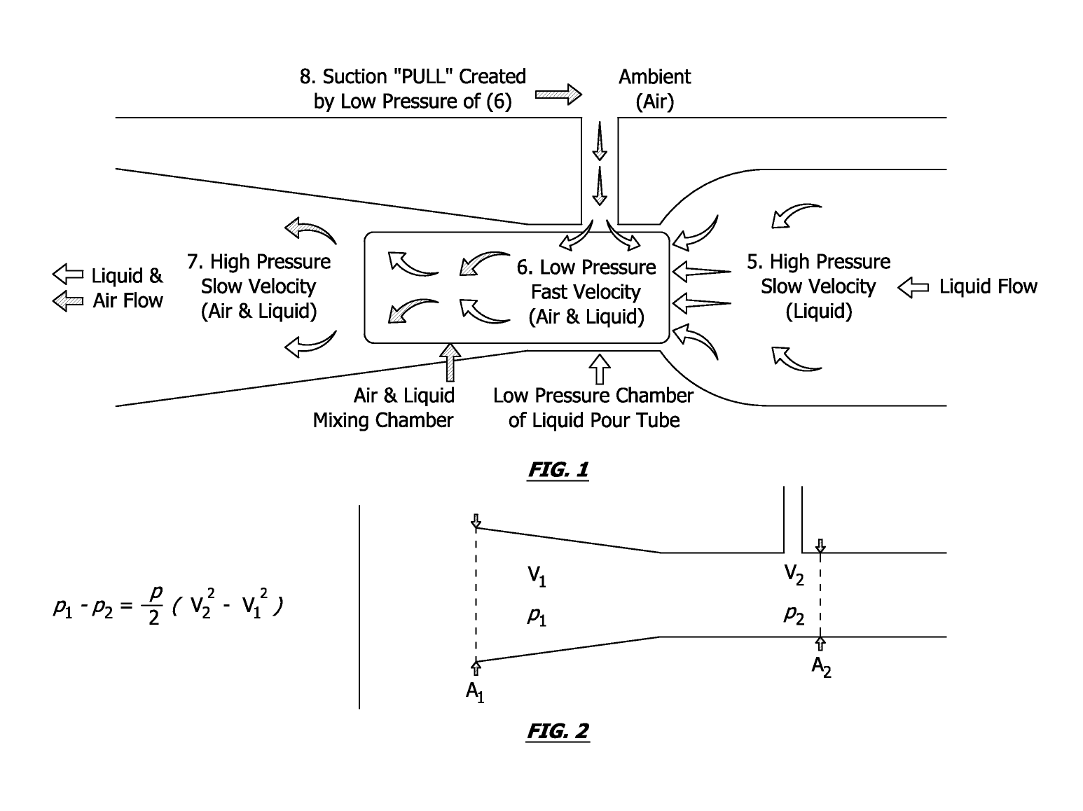

### DETAILED DESCRIPTION OF THE EMBODIMENTS

Exemplary embodiments of the present invention will now be described with referenced to the accompanying drawings.

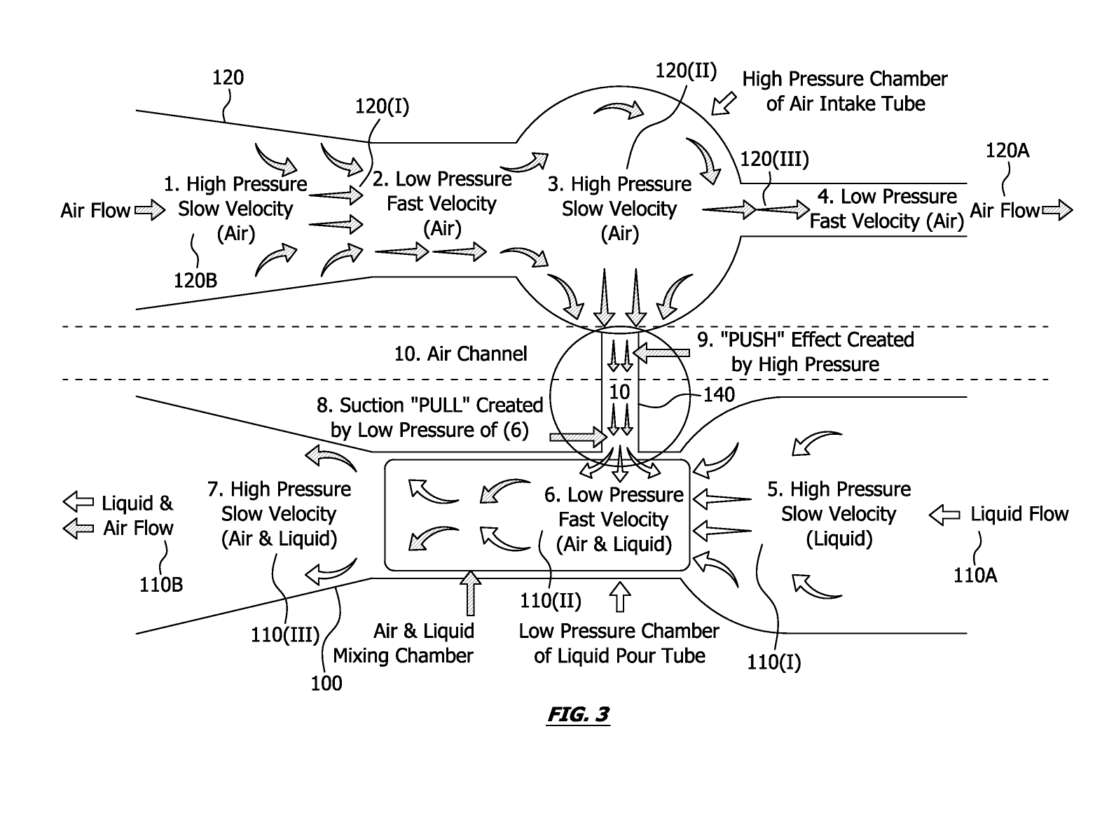

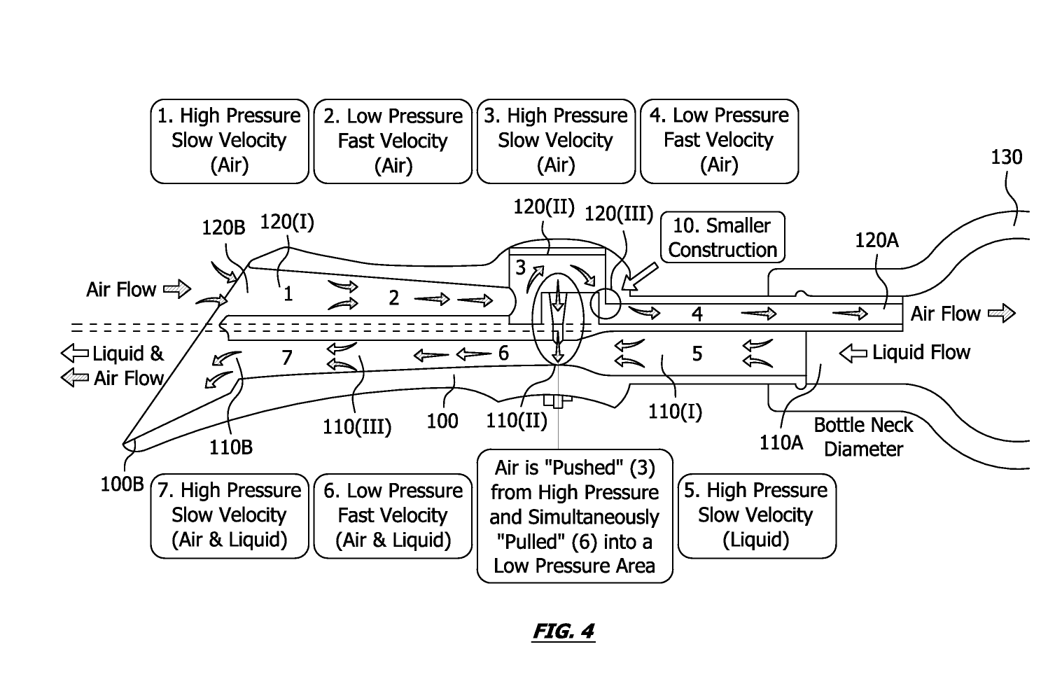

Referring to FIGS. 3 and 4, a first embodiment liquid aeration device is shown integrally formed in a wine pourer (100). The wine pourer (100) may be releasably attachable to a wine bottle, for instance by use of a collar which may for instance be friction-fitted around the neck of the wine bottle (130). It will be noted that the wine pourer may be used to also pour and aerate other liquids and beverages such alcoholic spirits and so on but for the purposes of this description will be referred to as a wine pourer.

The liquid aeration device includes a liquid pour conduit (110) and an air intake conduit (120) that extend substantially in parallel through a hollow body (100) of the wine pourer between an opening at one end (100A) of the hollow body (100) to a spout (100B) located at an opposing end of the hollow body (100). First ends (110A,120A) of the liquid pour conduit (110) and the air intake conduit (120) are configured for positioning inside the wine bottle (130) when the wine pourer (100) is releasably attached to the neck of the wine bottle (130), whilst second ends (110B,120B) of the liquid pour conduit (110) and the air intake conduit (120) are positioned outside of the wine bottle (130) adjacent the spout (100B) of the wine pourer (100). The liquid aeration device further includes an air feed conduit (140) which provides air flow communication from the air intake conduit (120) to the liquid pour conduit (110) the purpose of which will be described further below. In certain embodiments, the spout (100B) may include a drip catch surface having a shape contour configured for collecting and re-directing at least a portion of the beverage poured from the spout back into the chamber of the vessel via the opening of the vessel.

The liquid pour conduit (110) includes an internal shape configuration comprising three adjoining regions (110(I),110(II),110(III)) which will be described in order of position in a direction from the first end (110A) towards the second end (110B) of the liquid pour conduit (110). The first region (110(I)) adjacent the first end (110A) includes a relatively wide opening via which wine inside of the bottle (130) will first enter the liquid pour conduit (110) as the wine is being poured out. Thereafter, the first region (110(I) of the liquid pour conduit (110) adjoins a relatively constricted second region (110(II)) of relatively reduced diameter, and then finally, a third region (110(III)) comprising a gradually widening conduit section ending at and adjoining the spout (100B). This internal shape configuration of the liquid pour conduit (110) is adapted to generate a first pressure condition within the relatively constricted second region (110(II)) of the liquid pour conduit (110) as the liquid throws through the liquid pour conduit by virtue of the Venturi effect.

The air intake conduit (120) is positioned relatively above the liquid pour conduit (110) when wine is being poured from the bottle (130) such that when air flows in to the bottle (130), the air flows into the bottle (130) above the wine level inside of the bottle (130). The separate air intake (120) conduit assists in providing a relatively smoother and controlled flow of wine from the bottle (130) during pouring as inward flow of air entering the bottle (130) via the air intake conduit (120) does not need to obstruct outward flow of the wine through the liquid pour conduit (110) as it is being poured out. In this embodiment, the air intake conduit (120) includes an internal shape configuration also comprising three adjoining regions (120(I),120(II),120(III)) which will be described in order of position in a direction from the second end (120B) towards the first end (120A) of the air intake conduit (120). The first region (120(I)) adjacent the second end (120B) of the air intake conduit includes a relative wide opening via which air outside of the bottle (130) will first enter the air intake conduit (120) to fill the wine bottle (130) in response to the wine being poured out of the bottle (130). The diameter of the first region (120(I)) becomes increasingly constricted as it extends along the air intake conduit (120) to an adjoining second region (120(II)) comprising a relatively higher volume chamber. Thereafter, the second region (120(II)) leads to an adjoining third region (120(III)) having a diameter that is significantly more constricted than any of the preceding first and second regions (120(I),120(II)) of the air intake conduit (120). This internal shape configuration of the air intake conduit (120) generates a second pressure condition in the second region (120(II)) of the air intake conduit (120) by virtue of the Venturi effect.

The air feed conduit (140) is configured to connect the air intake conduit (120) to the liquid pour (110) conduit whereby a volume of the air from the second region (120(II)) in the air intake conduit (120) is able to be transferred to the second region (110(II)) in the liquid pour conduit (110) via the air feed conduit (140) in order to aerate the wine passing through the liquid pour conduit (110) during pouring. Conveniently, by virtue of this novel dual-Venturi tube configuration, air is able to be both drawn or “pulled’ in to the liquid pour conduit (110) from the adjoining air feed conduit (140) in response to the first pressure condition generated in the second region (110(II)) in the liquid pour tube (110) (as in the case of certain existing Venturi tube based aerators), but a volume of air is also able to be simultaneously forced or “pushed” into the air feed conduit (140) from the second region (120(II)) of the air intake conduit (120) in response to the second pressure condition that is generated in the second region (120(II)) in the air intake conduit as air flows through the air intake conduit (120). Accordingly, this simultaneous dual “push” and “‘pull” effect generated by the dual-Venturi tube configuration assists in providing a more effective transfer of air from the air intake conduit (120) to the liquid pour conduit (110) via the air feed conduit (140) to aerate the wine as it is being poured out via the liquid pour conduit (110) than in contrast to certain existing aeration devices which merely involve a single Venturi tube effect to draw ambient air in to a liquid pour conduit to effect aeration.

Embodiments of the present invention may be either integrally formed from a single material, or, may be assembled from separately formed component parts. Advantageously, as embodiments of the present invention may be substantially molded as a single-piece structure utilising existing molding techniques, such embodiments may not involve complex parts and components to achieve the desired functional aeration.

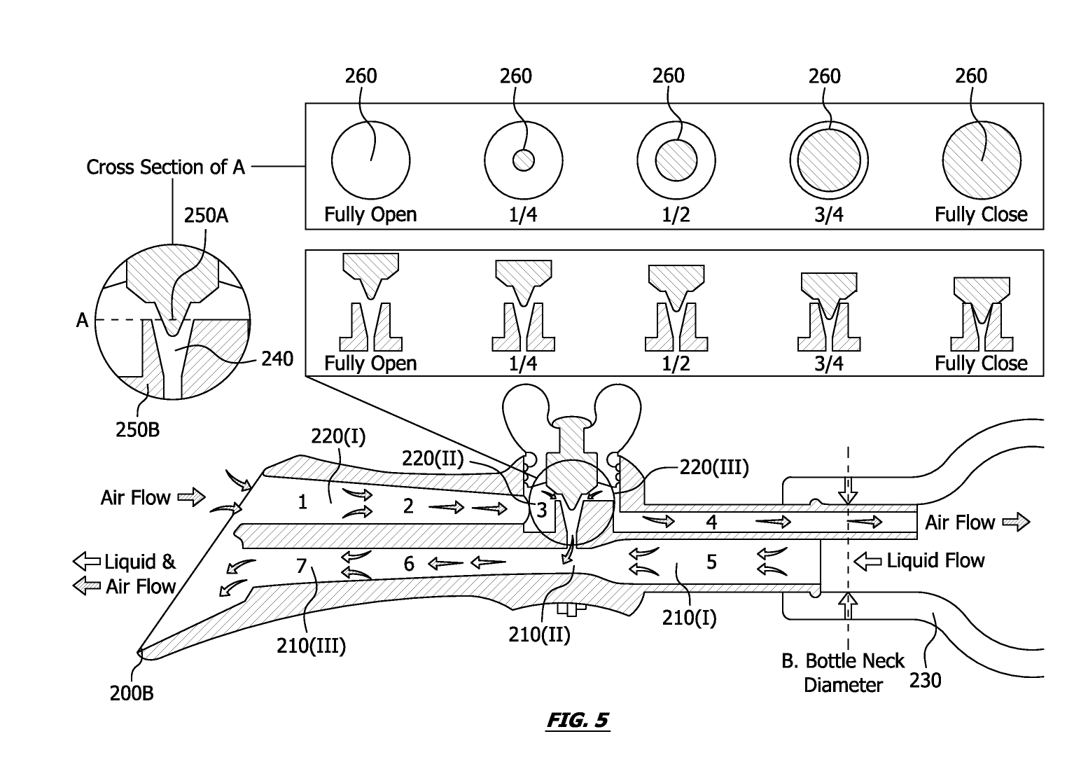

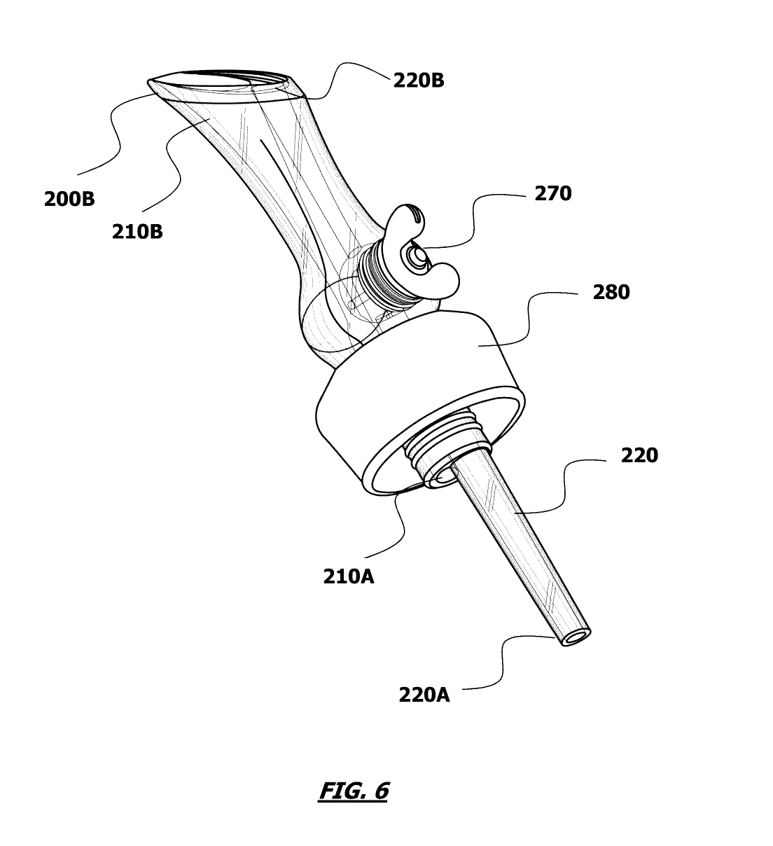

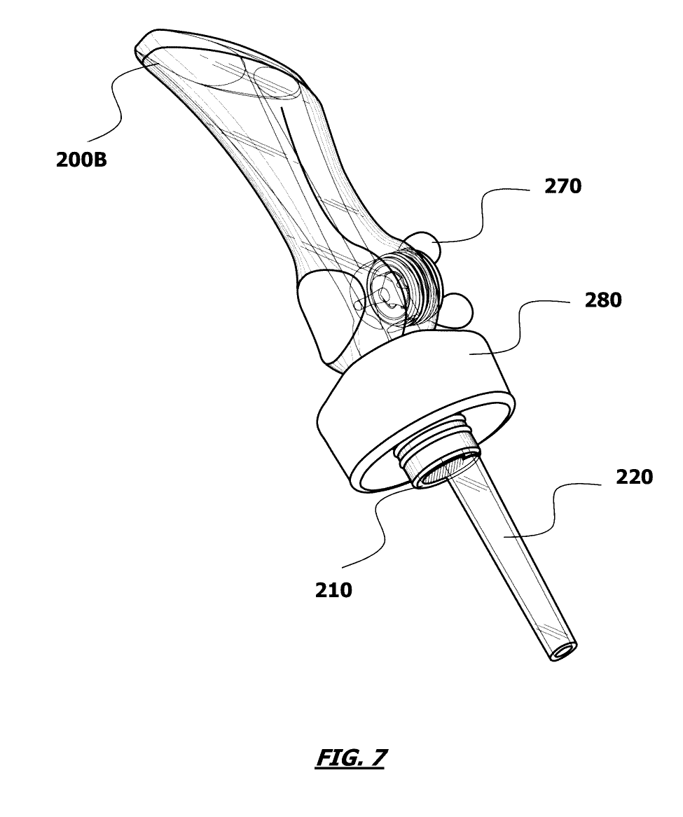

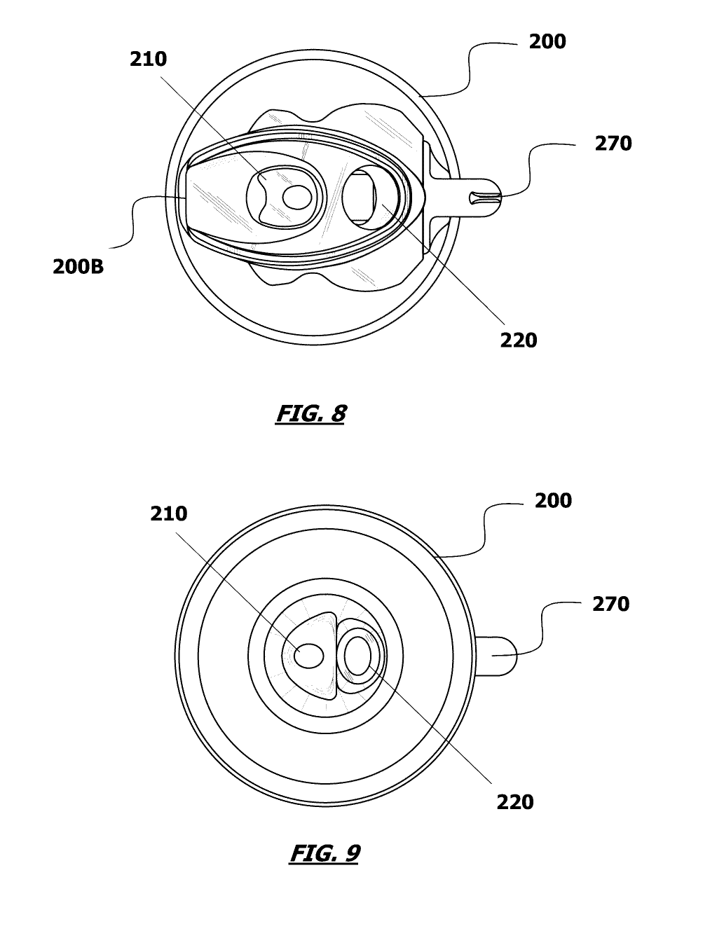

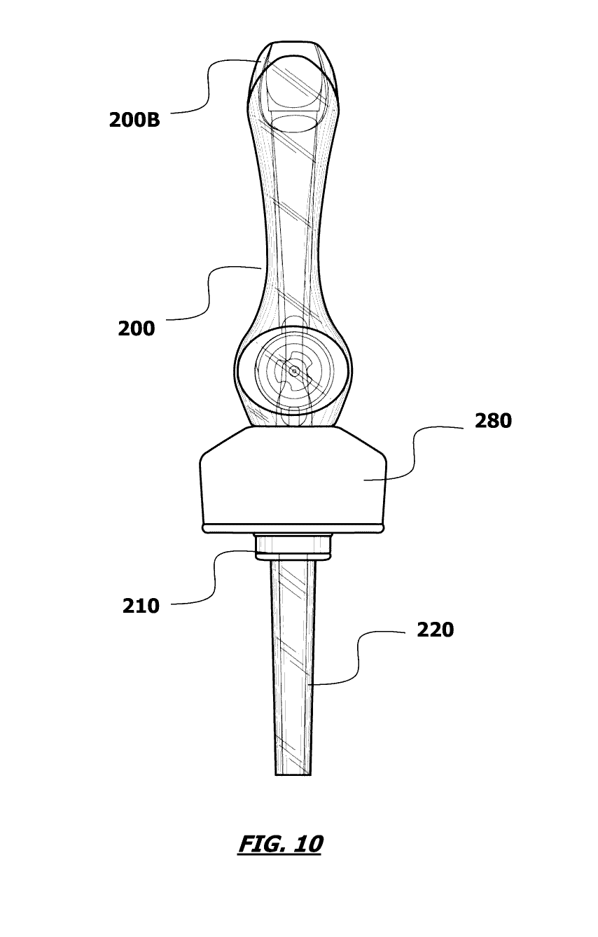

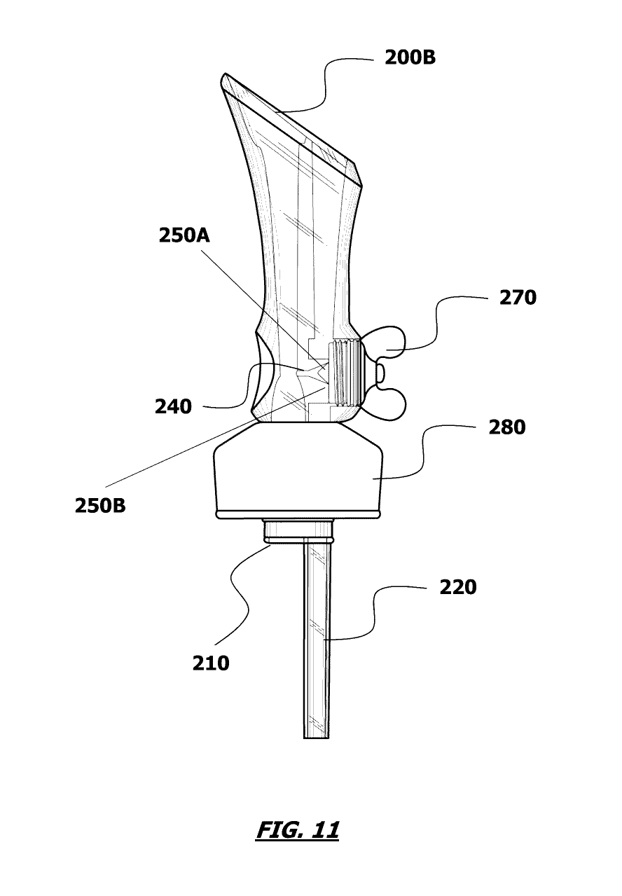

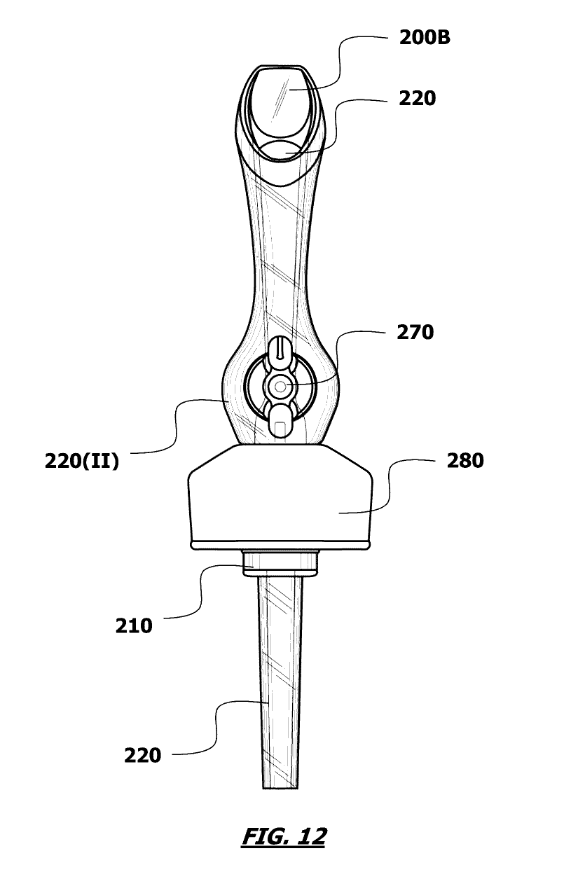

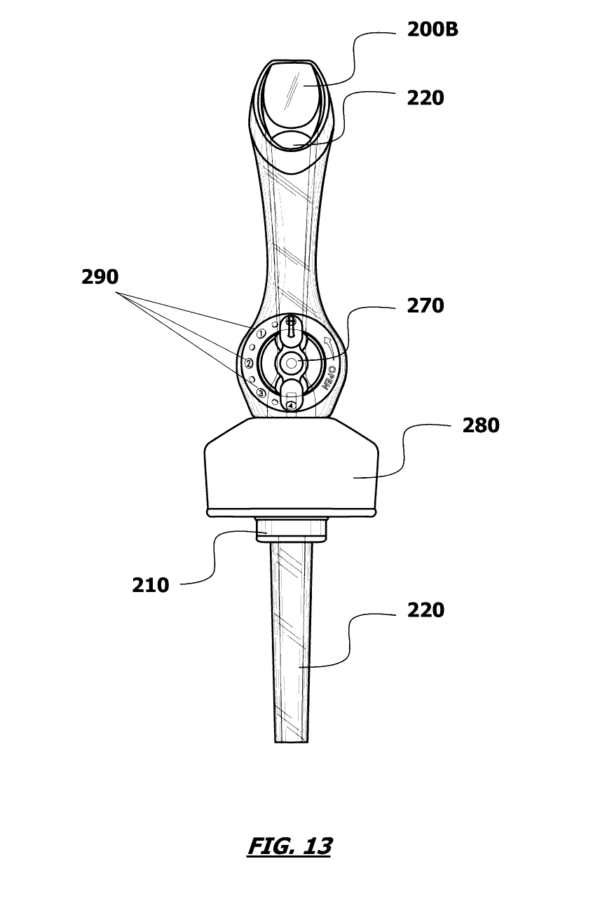

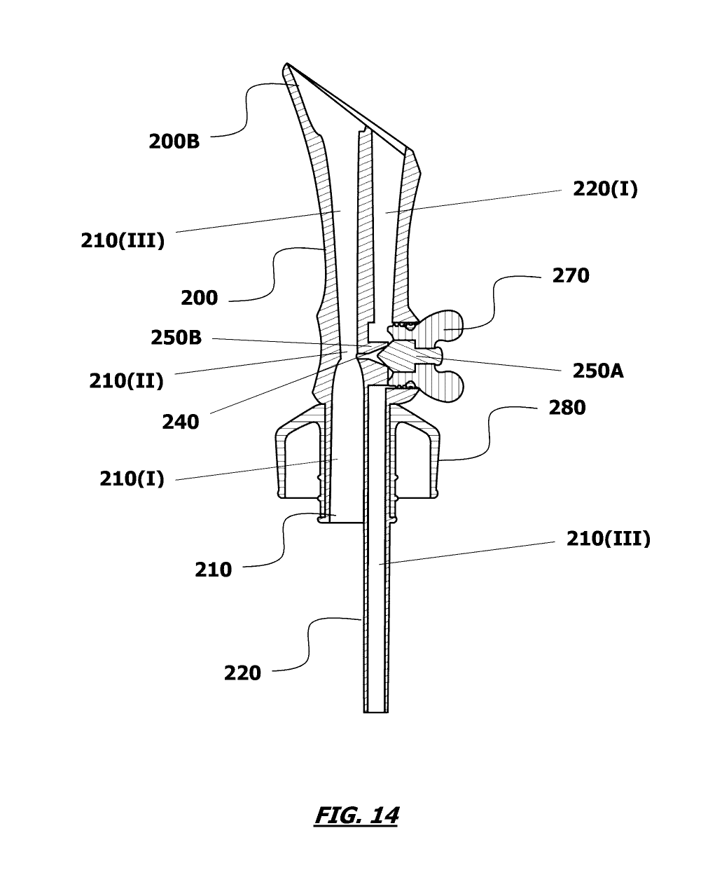

Referring now to FIGS. 5 to 19D shows a second embodiment of the present invention which includes the same features described above in respect of the first embodiment but also including a throttle valve assembly (250) for controlling and regulating flow of air along the air feed conduit (240) from the air intake conduit (220) towards the liquid pour conduit (210). The liquid pour conduit includes a first end (210A) and a second end (210B) and the air intake tube also include a first end (220A) and a second end (220B). The second embodiment is also integrally formed in a wine pourer (200) which is releasably attachable to a neck of a wine bottle using a collar member (280) which located around circumference of the pourer body (200).

The throttle valve assembly (250) includes a valve body (250A) that is movable relative to a valve seat (250) so as to control and regulate air flow therebetween. The valve body (250) includes an occlusion surface and the valve seat (250B) includes a seating surface which define an annular airflow passage (260) therebetween. Upon movement of the valve body closer towards the valve seat (250B), the annular airflow passage (260) is reduced in area so as to reduce airflow and a centroid of the annular airflow passage (260) remains coaxial with a longitudinal axis in a direction of the movement of the valve body (250A) towards the valve seat (250B). The valve body (250) occlusion surface (which is cone-shaped) and the seating surface are annular about the longitudinal axis and are inclined radially outwardly in a direction from the valve seat (250B) towards the valve body (250A). Advantageously, the annular airflow passage (260) alleviates air turbulence flowing into the air feed conduit (240) from the air intake conduit (220) in comparison to relatively “sharp-edged” other existing throttle configurations for wine aerators comprising multiple vertices.

In this embodiment, a threaded adjustment dial (270) is rotatably engaged with a corresponding threaded aperture in a sidewall of the hollow pour body (200) for controlling movement of the conical-shaped valve body (250A) relative to the valve seat (250B). The threaded adjustment dial (270) forms an air-tight seal with the threaded aperture to alleviate leakage of air from the air intake conduit (220). As the threaded adjustment dial (270) is rotated in a first direction, the apex of the conical-shaped valve body (250A) is moved closer towards the valve seat (250B) from a first configuration in which the annular airflow passage (260) is fully opened towards a second configuration in which the valve body (250A) presses against the valve seat (250B) to fully close the annular airflow passage (260). As the threaded adjustment dial (270) is rotated in a reverse direction, the conical-shaped valve body (250A) is moved away from the valve seat (250B) to gradually open the annular airflow passage (260) towards a maximally opened arrangement.

In this embodiment, the threaded adjustment dial (270) is selectably rotatable into at least 5 general settings in which the conical-shaped valve body (250A) is arranged at incrementally varying distances from the valve seat (250B) to provide variable degrees of aeration to the wine. As shown in FIG. 13, indicia (290) is provided on an outer surface of the pourer body (200) around the threaded adjustment dial (270) to indicate to the user in which of the 5 settings the throttle valve assembly (250) is arranged in at any given time. As different wine varietals and ages require different amounts of aeration, the ability to control the amount of aeration delivered provides a more efficient and effective process for aerating any given wine. For instance, for certain wines which are able to suitably breathe in a wine glass without any further aeration being required, the threaded adjustment dial (270) may be arranged in a suitable setting which fully closes the annular airflow passage so that no aeration is provided and the pourer is able to be used as an ordinary pourer device. Conversely, where the wine requires a greater degree of aeration, the threaded adjustment dial (270) may be suitably arranged to a setting in which the annular airflow passage (260) is maximally opened to ensure that a suitable amount of aeration is delivered to the wine being poured out.

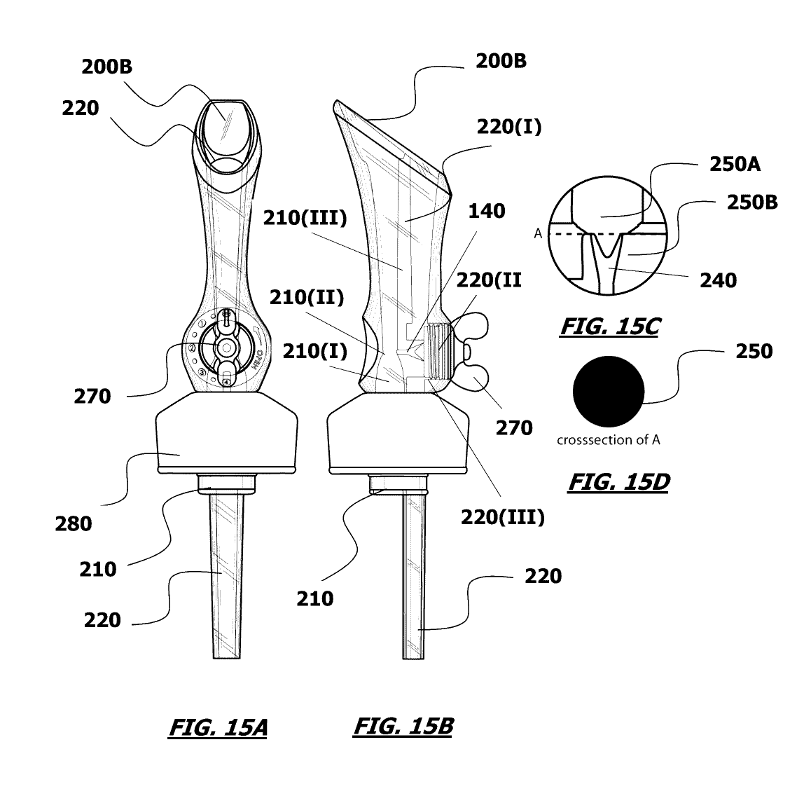

FIGS. 15A and 15B show front and left-side views of the threaded dial arranged in a first setting in which the annular airflow passage is fully closed. FIG. 15C shows the position of the valve body in relation to the valve seat when the annular airflow passage is fully closed whilst FIG. 15D is a cross-sectional view (taken across the sectional line “A” in FIG. 15C) of the annular airflow passage shown entirely in black representing the annular airflow passage as being fully closed.

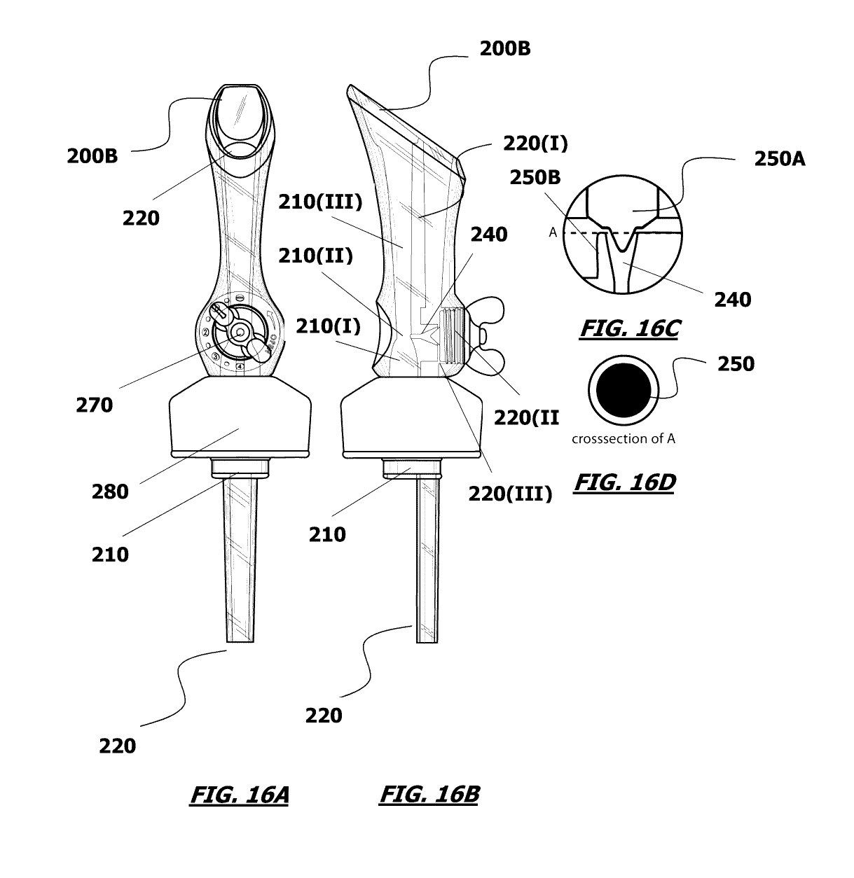

FIGS. 16A and 16B show front and left-side views of the threaded dial arranged in a second setting in which the annular airflow passage is only partially opened. FIG. 16C shows the position of the valve body in relation to the valve seat when the annular airflow passage is only partially opened whilst FIG. 16D is a cross-sectional view (taken across the sectional line “A” in FIG. 16C) of the annular airflow passage shown almost entirely in black and with a relatively small white outer ring representing the partial opening of the annular airflow passage.

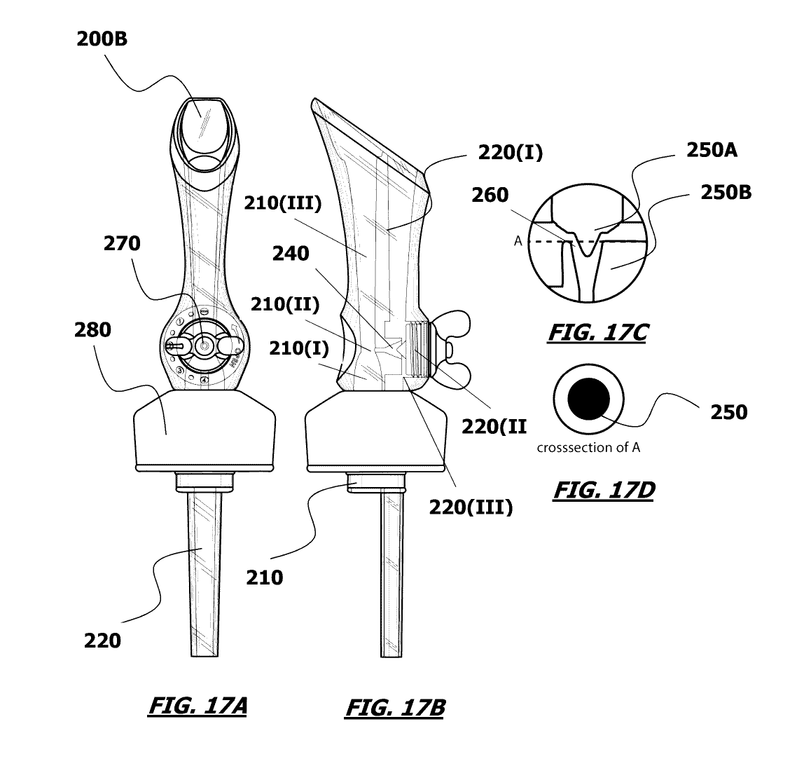

FIGS. 17A and 17B show front and left-side views of the threaded dial arranged in a third setting in which the annular airflow passage is opened slightly further than in the second setting. FIG. 17C shows the position of the valve body in relation to the valve seat when the annular airflow passage is opened slightly further in the third setting whilst FIG. 17D is a cross-sectional view (taken across the sectional line “A” in FIG. 17C) of the annular airflow passage shown mostly in black with and an outer white ring representing the partial opening of the annular airflow passage.

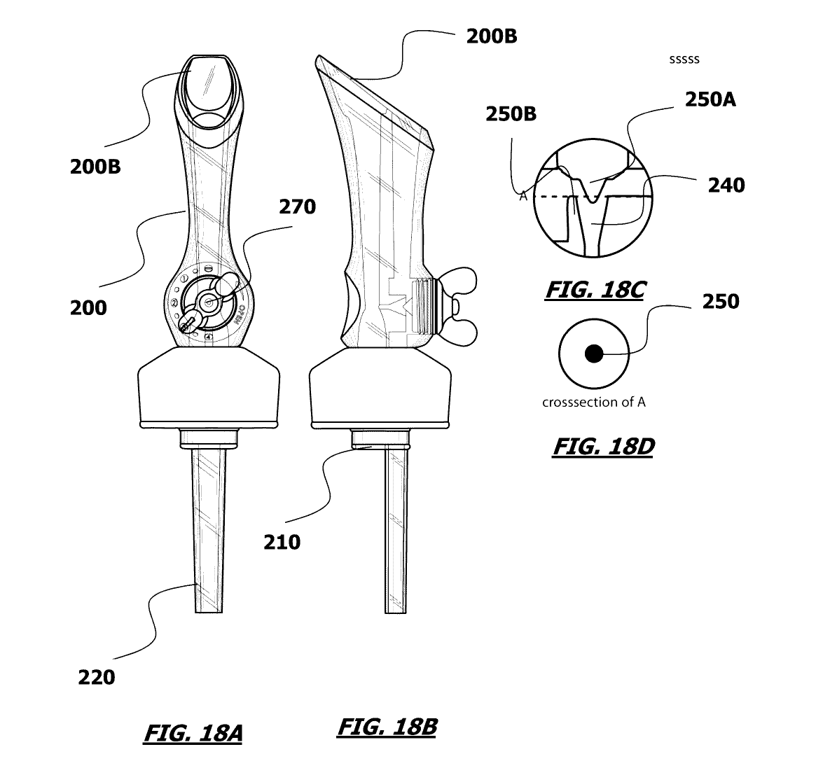

FIGS. 18A and 18B show front and left-side views of the threaded dial arranged in a fourth setting in which the annular airflow passage is opened slightly further than in the third setting. FIG. 18C shows the position of the valve body in relation to the valve seat when the annular airflow passage is opened slightly further in the third setting whilst FIG. 18D is a cross-sectional view (taken across the sectional line “A” in FIG. 18C) of the annular airflow passage shown mostly in white indicating that the annular airflow passage is mostly opened.

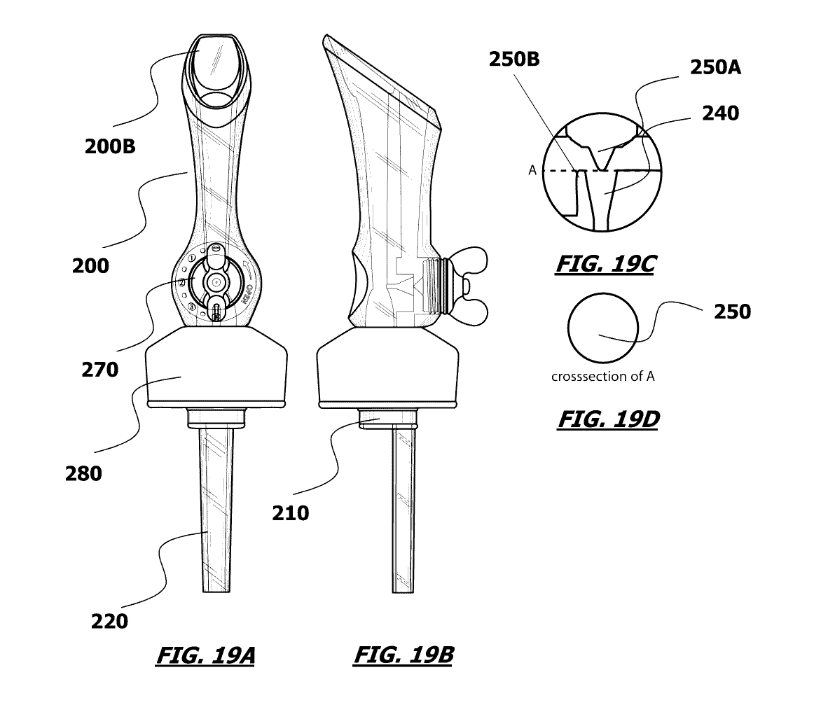

FIGS. 19A and 19B show front and left-side views of the threaded dial arranged in a fifth setting in which the annular airflow passage is fully opened. FIG. 19C shows the position of the valve body maximally displaced from the valve seat when the annular airflow passage is fully opened whilst FIG. 19D is a cross-sectional view (taken across the sectional line “A” in FIG. 19C) of the annular airflow passage shown entirely in white indicating that the annular airflow passage is fully opened.

In alternate embodiments of the present invention, movement of the valve body relative to the valve seat could be controlled by other suitable positioning mechanisms. For instance, instead of using a threaded dial mechanism engaged with a corresponding threaded aperture in the pourer body, a lever mechanism could be configured to incrementally position the valve body closer to or further away from the valve seat.

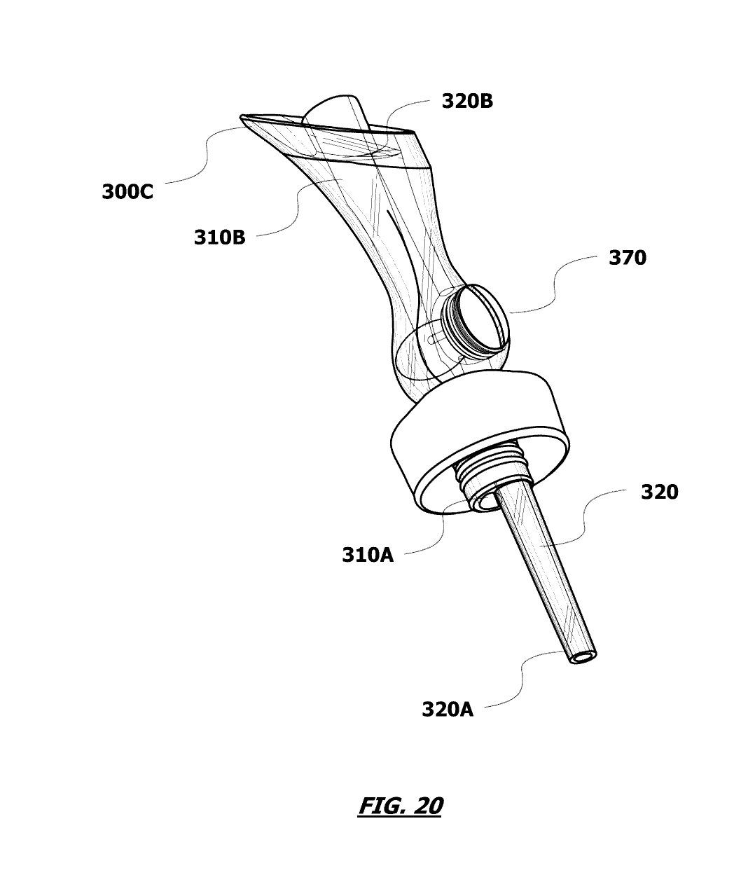

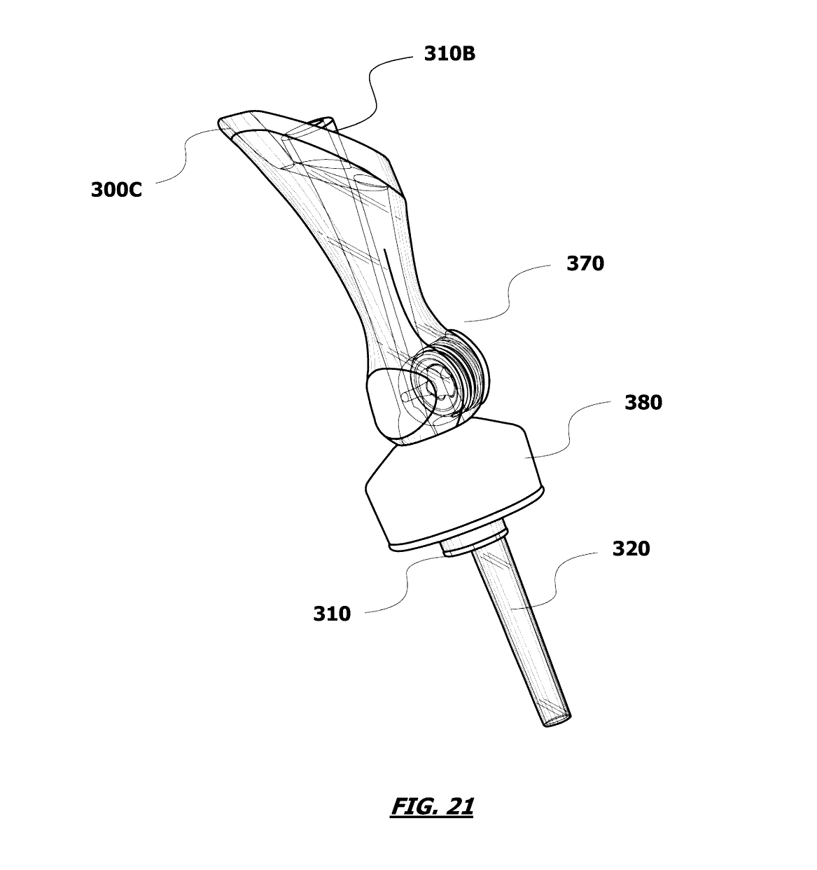

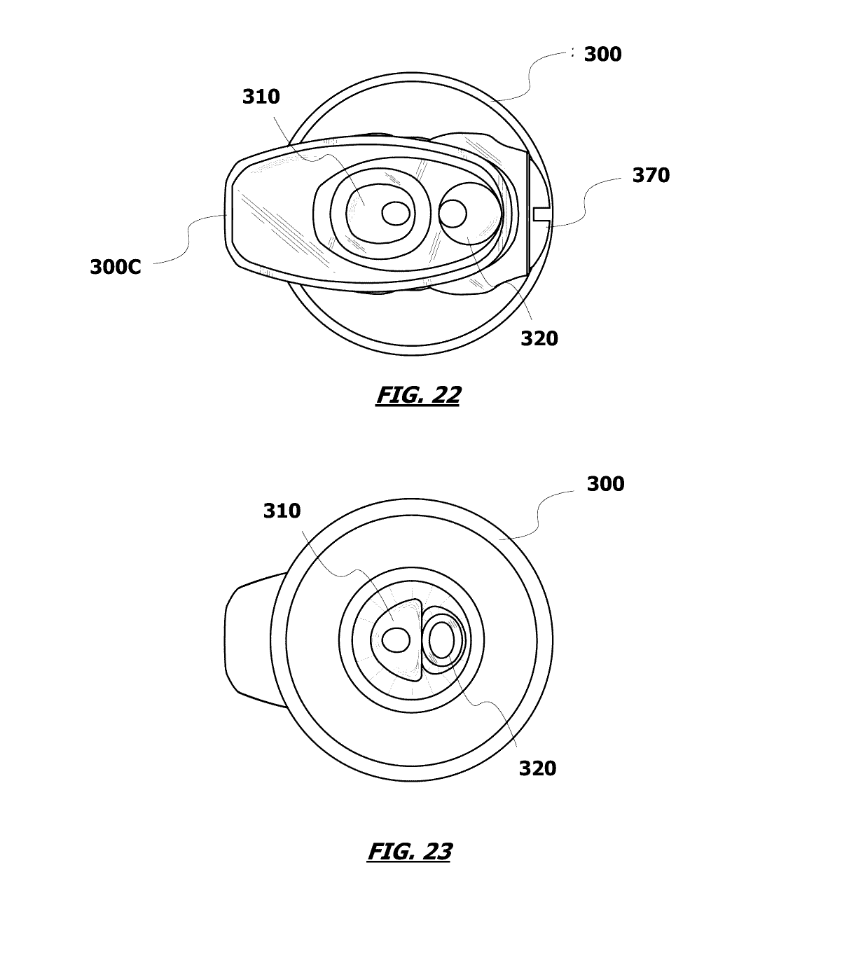

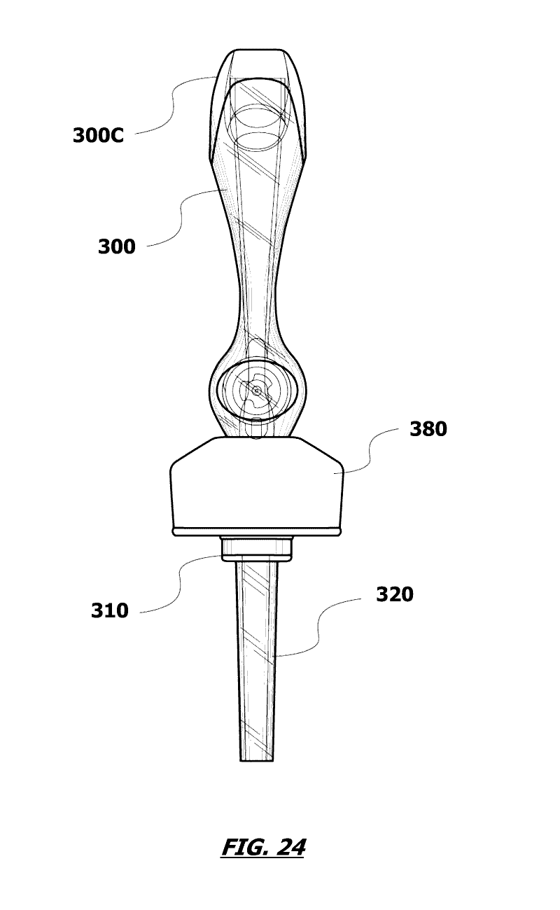

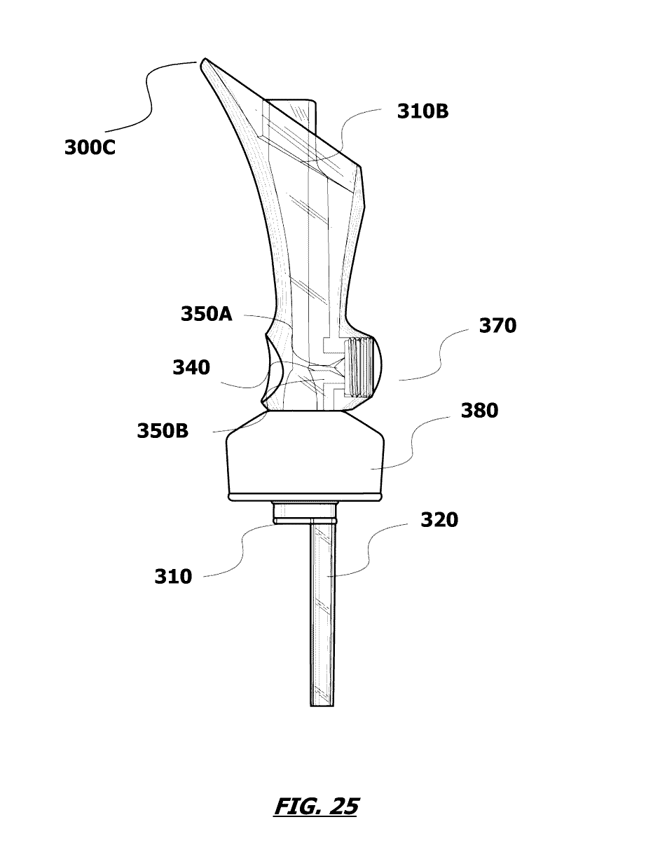

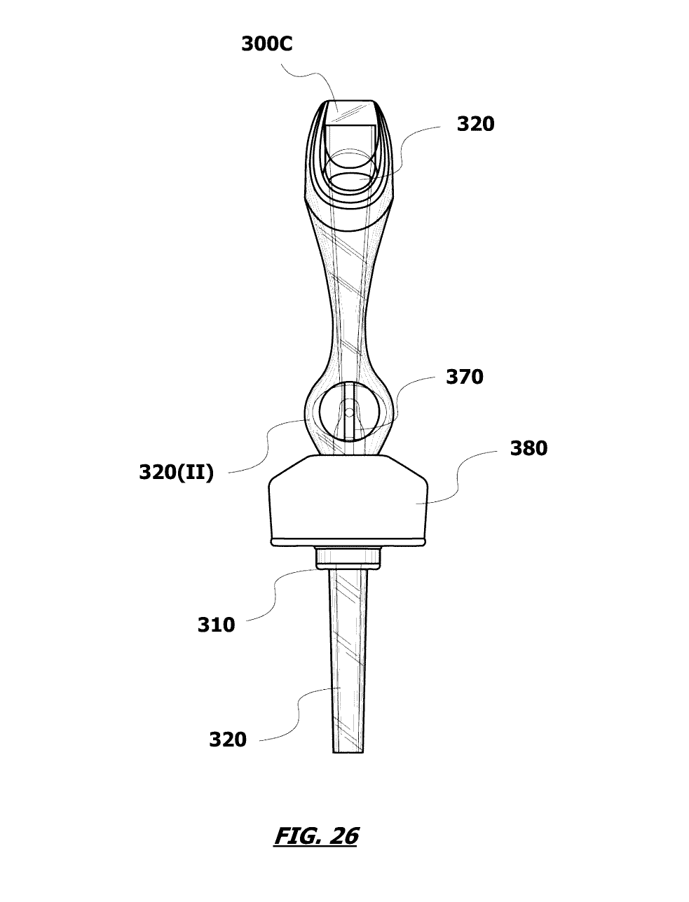

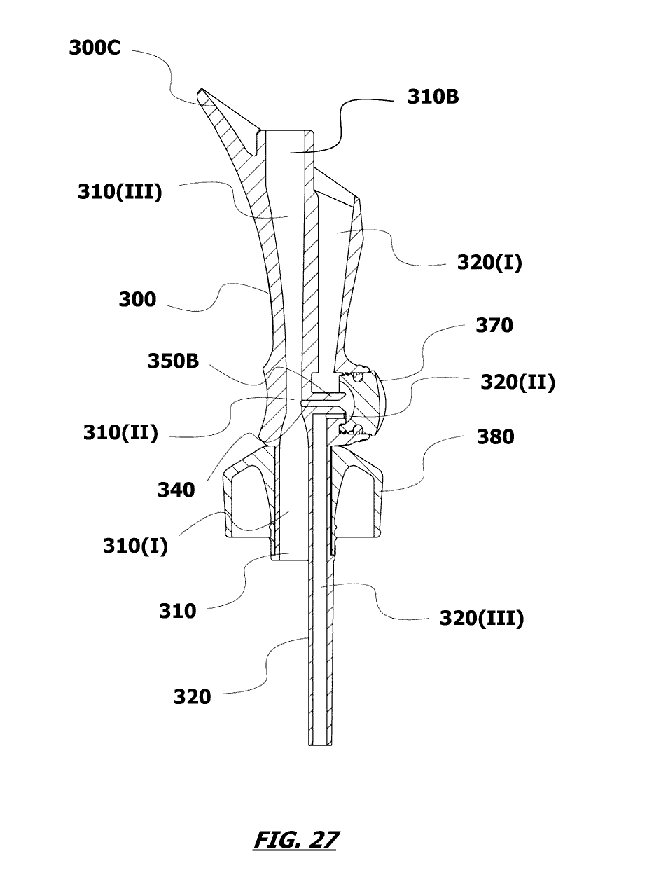

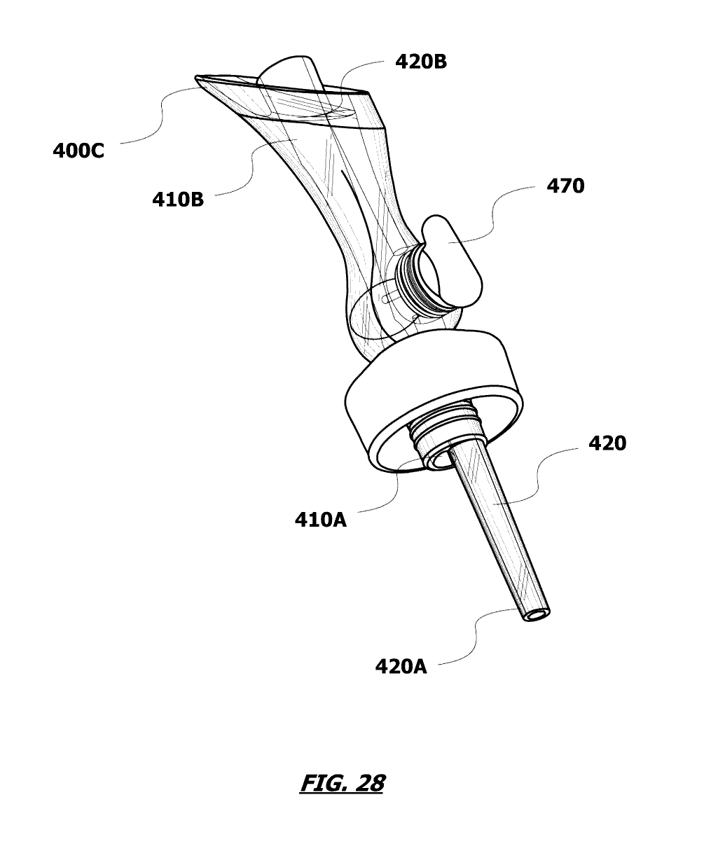

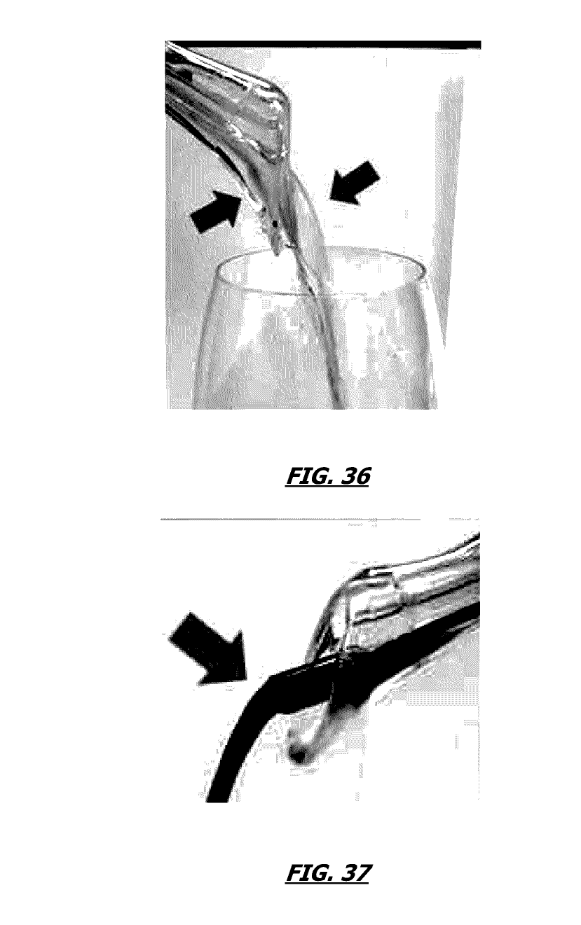

FIGS. 20 to 27 depicts another embodiment of the present invention comprising a beverage pourer having substantially similar functional features and method of operation as preceding embodiments described above except that in this embodiment, it does not include an adjustment means for adjusting the amount of aeration delivered to the beverage being poured. The beverage pourer also includes a tubular-shaped spout end which is configured for pouring a more controlled and focused stream of liquid therefrom as shown in FIG. 37. In comparison, a beverage pourer having a relatively flared spout tends to pour a less controlled and less focused stream of liquid therefrom as shown in FIG. 36 particularly where spirits or other high sugar content beverages with relatively high viscosity are being poured. In this embodiment, the beverage pourer may be releasably attachable to a beverage bottle, for instance by use of a collar (380) which may for instance be friction-fitted around the neck of the bottle. The liquid aeration device includes a liquid pour conduit (310) and an air intake conduit (320) that extend substantially in parallel through a hollow body of the beverage pourer between an opening at one end of the hollow body to a spout (310B) located at an opposing end of the hollow body. First ends (310A,320A) of the liquid pour conduit (310) and the air intake conduit (320) are configured for positioning inside the bottle when the beverage pourer is releasably attached to the neck of the bottle, whilst second ends (310B,320B) of the liquid pour conduit (310) and the air intake conduit (320) are positioned outside of the opening of the bottle. The liquid pour conduit (310) includes an internal shape configuration comprising three adjoining regions (310(I),310(II),310(III)) which will be described in order of position in a direction from the first end (310A) towards the second end (310B) of the liquid pour conduit (310). The first region (310(I)) adjacent the first end (310A) includes a relatively wide opening via which beverage inside of the bottle will first enter the liquid pour conduit (310) as the beverage is being poured out. Thereafter, the first region (310(I)) of the liquid pour conduit (310) adjoins a relatively constricted second region (310(II)) of relatively reduced diameter, and then finally, a third region (310(III)) comprising a gradually widening conduit section which at its end comprises the tubular-shaped spout section (310B) of relatively uniform diameter as shown in the cross-sectional view of FIG. 27 to effect the relatively controlled and focused pour. An air feed conduit (340) provides air flow communication from the air intake conduit (320) to the liquid pour conduit (310). An annular air-flow passage of fixed dimensions is provided into the air feed conduit (340) from the second chamber of the air intake conduit (320) wherein the air-flow passage is defined between a first surface (350A) in fixed proximity to a second surface (350B) disposed on member (370). In certain embodiments, the spout (310B) may include a drip catch surface (300C) having a shape contour configured for collecting and re-directing at least a portion of the beverage poured from the tubular-shaped spout (310B) back into the bottle via the opening of the bottle.

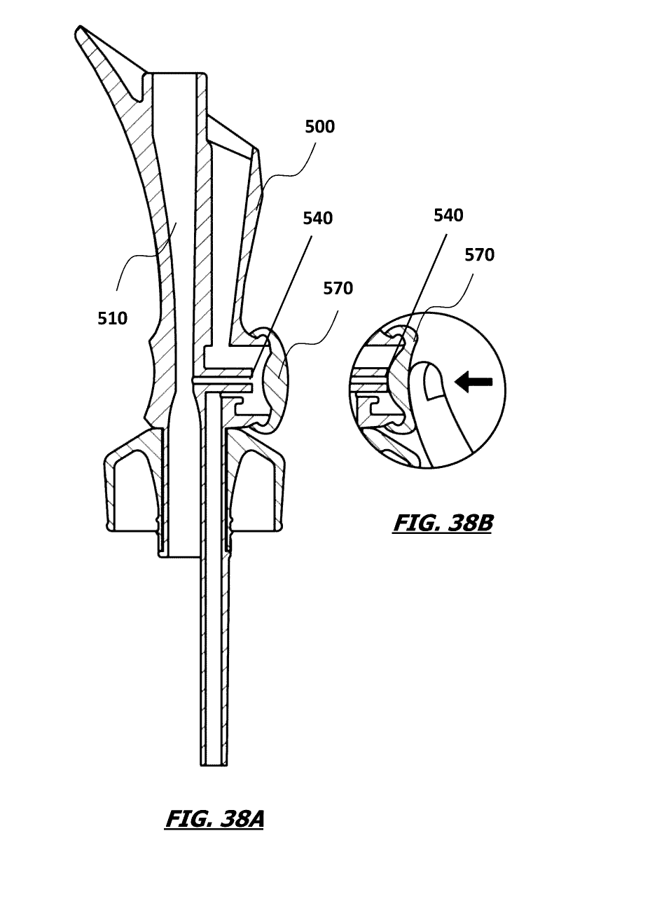

A variation upon the pourer embodiment shown in FIGS. 20-27 is depicted in FIGS. 38A and 38B. In this variation, the member (370) shown in FIGS. 20-27 is replaced with a depressible wall member (570) in the pourer embodiment (500) of FIGS. 38A and 38B which when depressed is configured to occlude the opening (540) of the air passage from the air intake conduit to the liquid pour conduit. The depressible wall member (570) may be formed from an elastically deformable material such that after being depressed by a user's finger as shown in FIG. 38A, upon release, the depressible wall member may return to its initial undepressed state as shown in FIG. 38B. Whilst in this embodiment, the opening (540) of the air passageway is entirely occluded when the depressible wall is depressed, it is possible that the user may manually position the depressed wall surface over only a portion of the opening of the air passageway to manually control air flow from the air intake conduit to the liquid pour tube. It should be noted that the novel depressible wall member may also be suitably implemented in a conventional single Venturi tube type aerator device comprising only a single liquid pour tube (i.e. without the air intake tube). Typically, in such conventional single Venturi tube type aerators, an air vent will provide flow of air along an air channel from an air inlet disposed on an outer wall of the aerator towards a relatively low pressure chamber in the single Venturi tube where the inflowing air mixes with liquid pouring through the low pressure chamber in the Venturi tube. The depressible wall member may form part of the outer wall of the aerator and be suitably located thereon whereby when moved in to a depressed position by the user's finger, the wall member may be positioned to partially or wholly occlude the air vent.

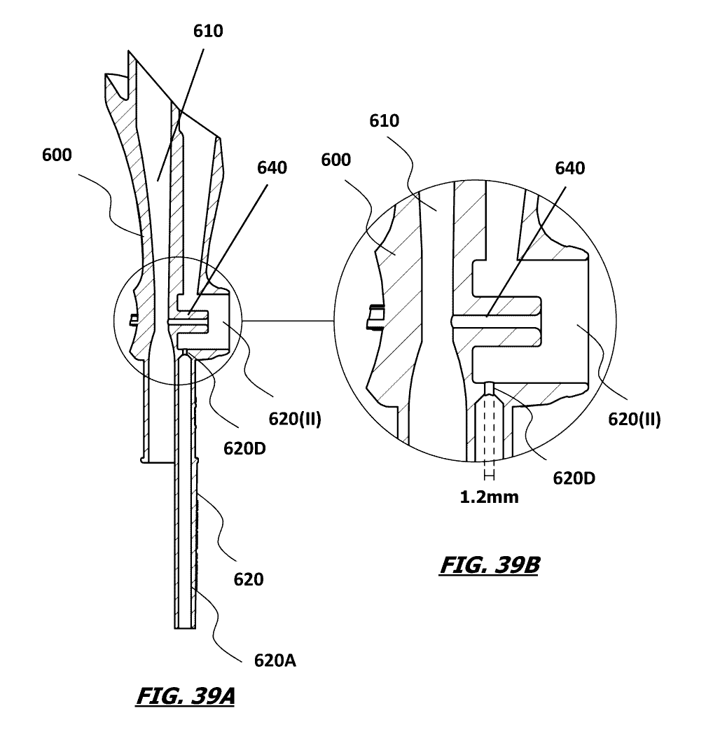

FIGS. 39A and 39B show another embodiment pourer (600) of the present invention including yet a further variation in its aeration functionality which may be implemented in any of the other embodiments described. The variation comprises the addition of a constricted region (620D) disposed along the air intake conduit (620) between the first end (620A) of the air intake conduit and the second region (620(II)) in the second conduit in which the second pressure condition is generated, as shown in FIG. 39A. The constricted region (620D) includes a diameter of approximately 1.2 mm which separately assists in increasing the pressure of the low velocity area of (620(II)), so as to improve the ‘push’ effect to push air into the air feed conduit (640) from the air intake conduit (620). Also, the variation assists in decreasing the rate of air moving into the bottle via the air intake conduit (620) thus slowing down the liquid being poured out of the bottle via the liquid pour conduit (610). This is perceived to improve the liquid to air ratio and increases the volume of air in contact with the liquid during pouring. It should be noted that the novel depressible wall member may be suitably implemented in a conventional single Venturi tube type aerator comprising only a single liquid pour tube.

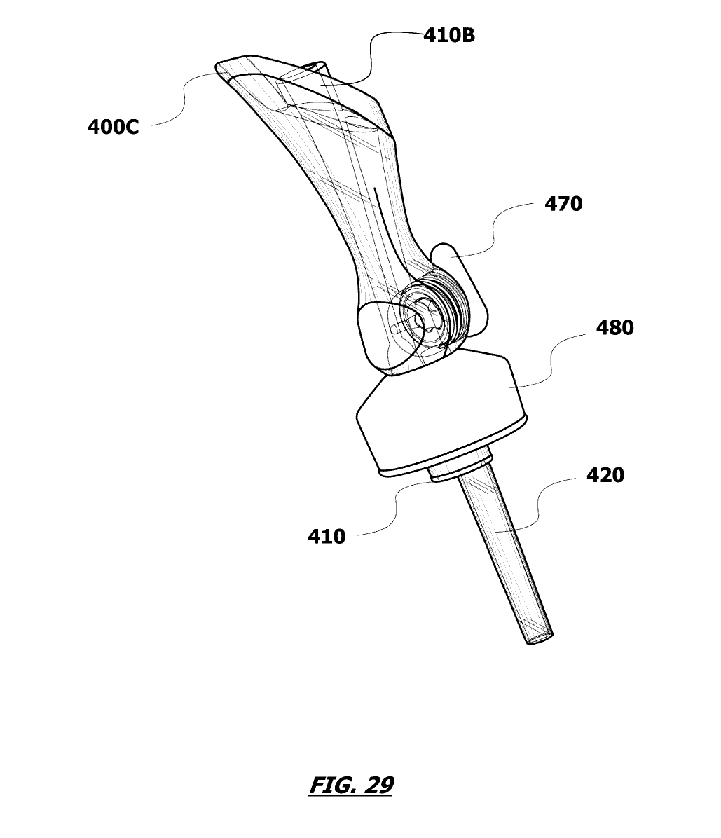

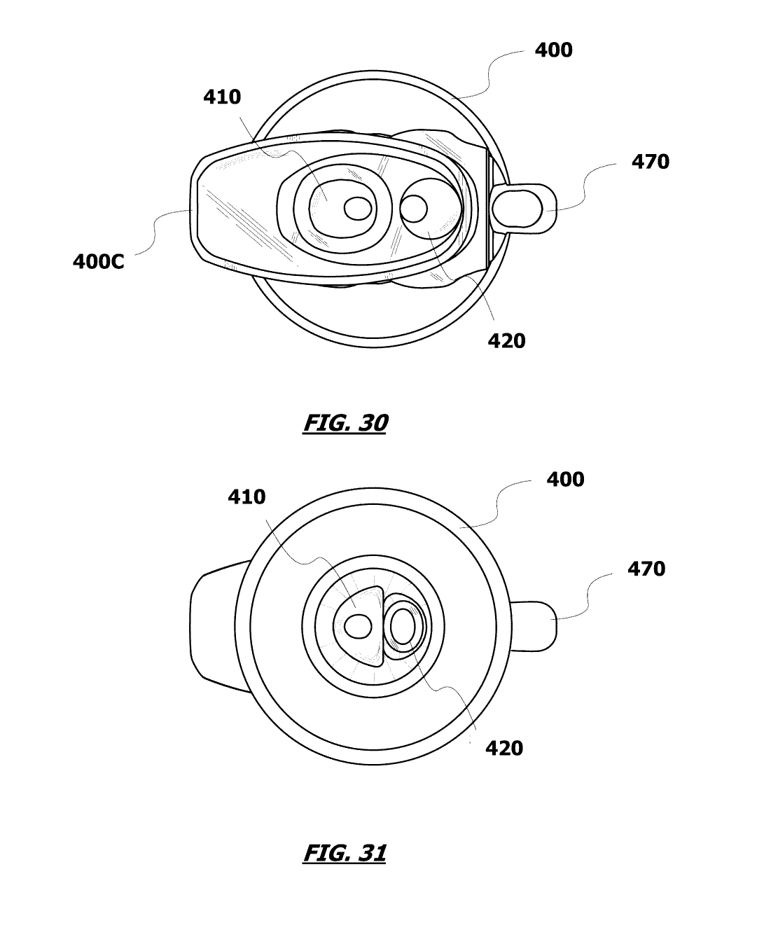

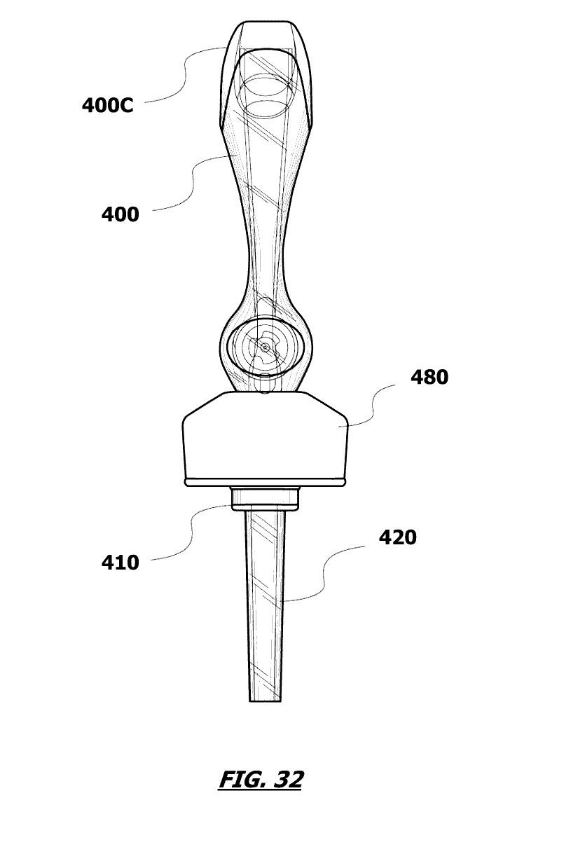

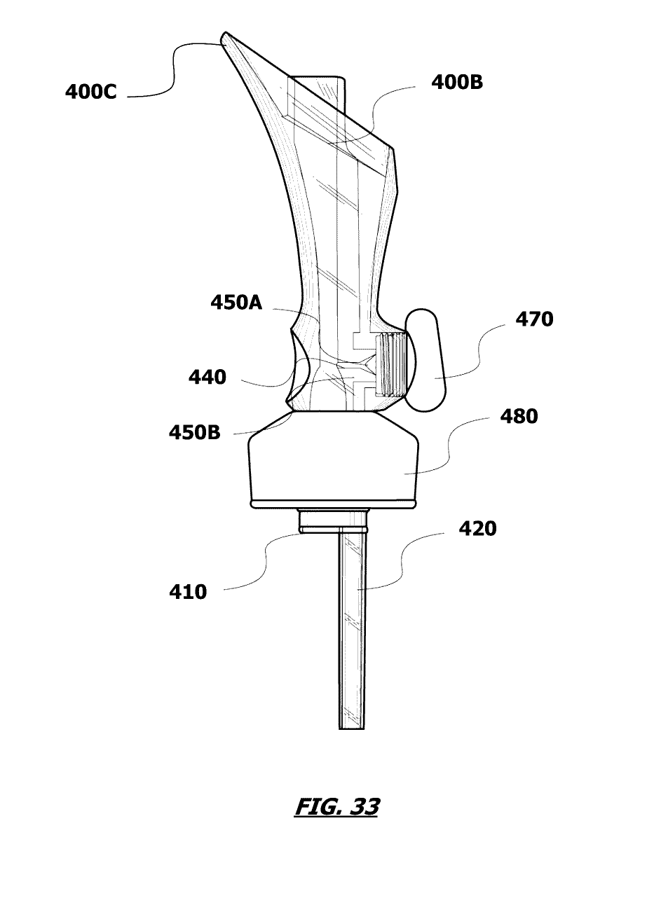

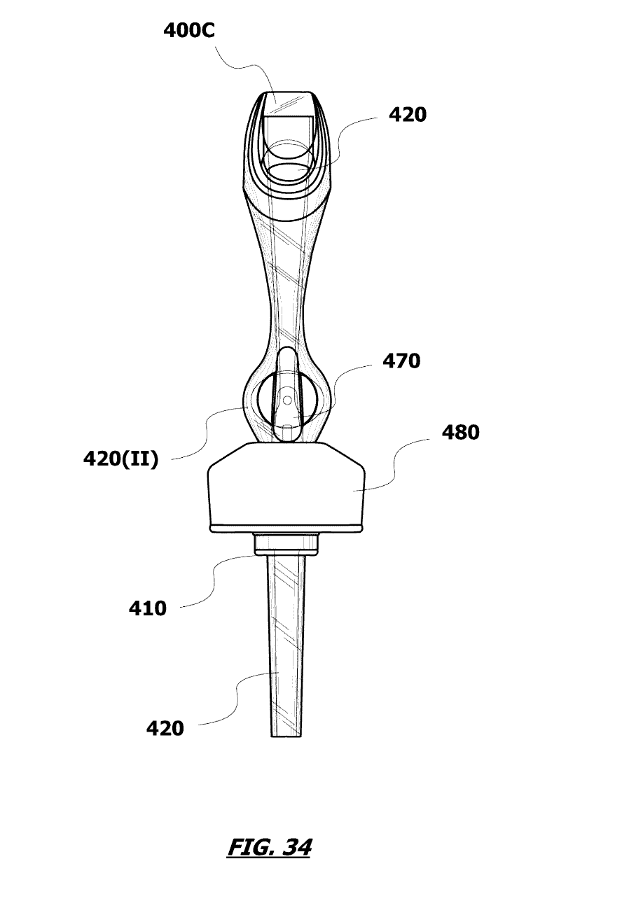

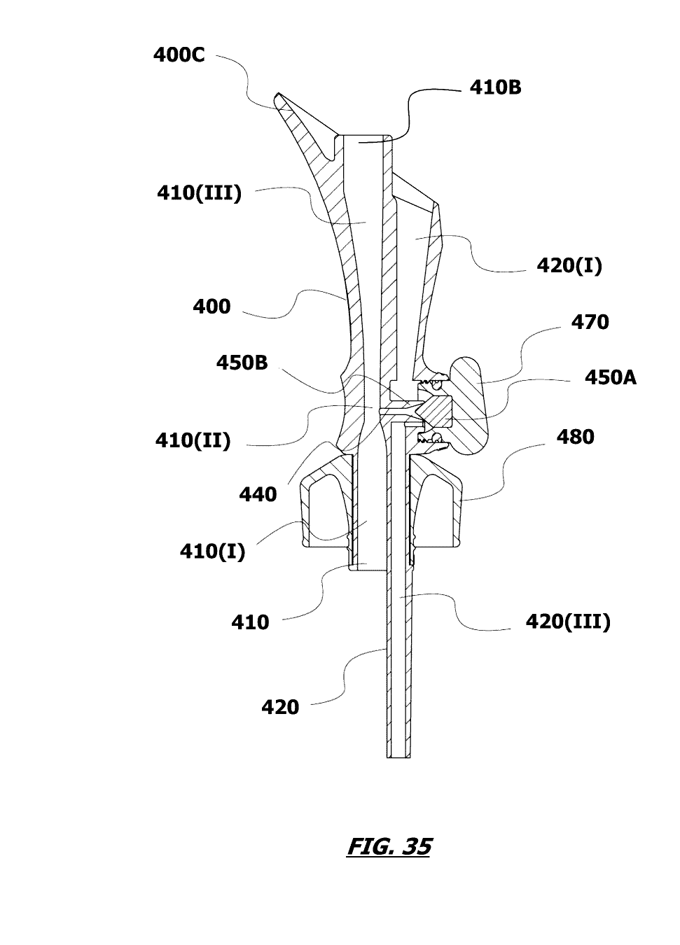

FIGS. 28 to 35 depicts a further embodiment of the present invention comprising a beverage pourer having substantially the similar functional features and method of operation as the embodiment depicted in FIGS. 20 to 27 except that in this embodiment, a threaded adjustment dial (470) is provided for adjusting the amount of aeration delivered to the beverage being poured. The beverage pourer also includes a relatively streamlined tubular-shaped spout (410B) which is configured for pouring a more controlled and focused stream of liquid therefrom as shown in FIG. 37. In comparison, a beverage pourer having a relatively flared spout tends to pour a less controlled and less focused stream of liquid therefrom as shown in FIG. 36 particularly where spirits or other high sugar content beverages with relatively high viscosity are being poured. In this fourth embodiment, the beverage pourer may be releasably attachable to a beverage bottle, for instance by use of a collar (480) which may for instance be friction-fitted around the neck of the bottle. The liquid aeration device includes a liquid pour conduit (410) and an air intake conduit (420) that extend substantially in parallel through a hollow body of the beverage pourer between an opening at one end of the hollow body to a spout (410B) located at an opposing end of the hollow body. First ends (410A,420A) of the liquid pour conduit (410) and the air intake conduit (420) are configured for positioning inside the bottle when the beverage pourer is releasably attached to the neck of the bottle, whilst second ends (410B,420B) of the liquid pour conduit (410) and the air intake conduit (420) are positioned outside of the opening of the bottle. The liquid pour conduit (410) includes an internal shape configuration comprising three adjoining regions (410(I),410(II),410(III)) which will be described in order of position in a direction from the first end (410A) towards the second end (410B) of the liquid pour conduit (410). The first region (410(I)) adjacent the first end (410A) includes a relatively wide opening via which beverage inside of the bottle will first enter the liquid pour conduit (410) as the beverage is being poured out. Thereafter, the first region (410(I)) of the liquid pour conduit (410) adjoins a relatively constricted second region (410(II)) of relatively reduced diameter, and then finally, a third region (410(III)) comprising a gradually widening conduit section which at its end comprises the tubular-shaped spout section (410B) of relatively uniform diameter as shown in the cross-sectional view of FIG. 35 to effect the relatively controlled and focused pour. An air feed conduit (440) provides air flow communication from the second chamber of the air intake conduit (420) to second chamber of the liquid pour conduit (410). An annular air-flow passage is provided into the air feed conduit (440) from the second chamber of the air intake conduit (420) wherein the air-flow passage is adjustable by a throttle valve assembly comprising a valve body (450A) selectably movable relative to a valve seat (450B) of the valve assembly to either increase or decrease the amount of aeration delivered. Movement of the valve body (450A) relative to the valve seat (450B) is controlled by turning the threaded aeration adjustment dial (470) which is operably connected to the valve body (450A). In certain embodiments, the tubular-shaped spout (410B) may include a drip catch surface (400B) having a shape contour configured for collecting and re-directing at least a portion of the beverage poured from the tubular-shaped spout (410B) back into the bottle via the opening of the bottle.

It will be appreciated that the broad forms of the present invention may provide at least one of the following advantages:
(i) the novel dual Venturi tube configuration allows for ambient air to be not only drawn or “pulled” in to the liquid pour conduit from the adjoining air feed conduit in response to the first pressure condition generated by the internal shape configuration of this Venturi tube as the liquid flows therethrough, but also, simultaneously enables ambient air to be “pushed” in to the air feed conduit from the air intake conduit in response to the second pressure condition generated by the internal shape configuration of this second Venturi tube as the air flows therethrough;
(ii) the simultaneous “push” and “pull” effect may be relatively simply effected by virtue of the internal shape configurations of the dual Venturi tubes suitably connected via the air feed conduit. The dual Venturi tubes used to achieve the “push” and “pull” effect the transfer of air into the liquid pour conduit from the air intake conduit may be integrally formed utilising existing techniques relatively easily and cost-effectively thereby avoiding the need for utilisation of any additional and more complex/costly components to provide aeration;
(iii) the additional aeration ability provided by the dual-Venturi tube configuration may be embodied in an in-bottle type aerator, such that the in-bottle type aerator may be of comparable aeration performance to that of a hand-held type aerator notwithstanding the limitations on size and dimensions of the in-bottle type aerator;
(iv) as the present invention may be embodied in an in-bottle type aerator of comparable performance to that of a hand-held type aerator, it may be conveniently fitted to a wine bottle opening and used to both pour and aerate wine directly in to a wine glass in a single-step without the use of any additional equipment;
(v) the inclusion of an adjustable occlusion device provides control and regulation of the amount of air flow in to the liquid pour conduit to aerate the wine such that different wine varietals and ages may be suitably processed without over-aerating or under-aerating the wine; and
(vi) the annular airflow passage of the occlusion device provides less air turbulence than in contrast to other throttle assemblies used in wine aerators and thereby assists in enhancing the flow of air in to the liquid pour conduit during the aeration process.

Those skilled in the art will appreciate that the invention described herein is susceptible to variations and modifications other than those specifically described without departing from the scope of the invention. All such variations and modification which become apparent to persons skilled in the art, should be considered to fall within the spirit and scope of the invention as broadly hereinbefore described. It is to be understood that the invention includes all such variations and modifications. The invention also includes all of the steps and features, referred or indicated in the specification, individually or collectively, and any and all combinations of any two or more of said steps or features.

The reference to any prior art in this specification is not, and should not be taken as, an acknowledgment or any form of suggestion that that prior art forms part of the common general knowledge.

What is claimed is:

1. A liquid aeration device including:
a first conduit for providing liquid communication between a first end and a second end of the first conduit;
a second conduit for providing air communication between a first end and a second end of the second conduit;
a third conduit being configured for providing air communication therethrough between the first conduit and the second conduit;
the first conduit including an internal shape configuration adapted for generating a first pressure condition therein as the liquid flows therethrough wherein air in the third conduit is able to be drawn in to the first conduit in response to the first pressure condition being generated in the first conduit, and, the second conduit including an internal shape configuration adapted for generating a second pressure condition therein as the air flows therethrough wherein air in the second conduit is able to be forced in to the third conduit in response to the second pressure condition being generated in the second conduit, whereby at least a volume of air flowing through the second conduit is able to be transferred via the third conduit in to contact with the liquid flowing through the first conduit to aerate the liquid.

2. A liquid aerator as claimed in claim 1 wherein the first conduit includes a first Venturi tube having an internal shape configuration adapted for generating the first pressure condition in the first conduit.

3. A liquid aerator as claimed in claim 1 wherein the second conduit includes a second Venturi tube having an internal shape configuration adapted for generating the second pressure condition in the second conduit.

4. A liquid aerator as claimed in claim 1 wherein the first conduit is configured for attachment to a liquid-containing vessel wherein the first conduit is positioned to allow the liquid in the vessel to be poured from the opening of the vessel via the first conduit.

5. A liquid aerator as claimed claim 4 wherein the second conduit is configured for attachment to a liquid-containing vessel wherein the second conduit is positioned to allow air to flow into the liquid-containing vessel via the second conduit whereby the air is able to fill the vessel in response to the liquid being poured from the opening of the vessel.

6. A liquid aerator as claimed in claim 1 wherein the first conduit and the second conduit are integrally formed in a pourer that is releasably attachable to the vessel to allow pouring of the liquid from the vessel.

7. A liquid aerator as claimed in claim 1 including an occlusion device for regulating flow of air along the third conduit from the second conduit towards the first conduit.

8. A liquid aerator as claimed in claim 7 wherein the occlusion device includes a throttle valve assembly.

9. A liquid aerator as claimed in claim 8 wherein the throttle valve assembly includes a valve body movable relative to a valve seat so as to control and regulate air flow therebetween, wherein the valve body includes an occlusion surface and the valve seat includes a seating surface which define an annular airflow passage therebetween, whereby:
(i) upon movement of the valve body towards the valve seat, the annular airflow passage is reduced in area so as to reduce airflow; and
(ii) a centroid of the annular airflow passage remains coaxial with a longitudinal axis in a direction of the movement of the valve body towards the valve seat.

10. A liquid aerator as claimed in claim 7 wherein the occlusion surface and the seating surface are annular about the longitudinal axis and are inclined radially outwardly in a direction from the valve seat towards the valve body.

11. A liquid aerator as claimed in claim 7 wherein the valve body includes a conical configuration.

12. A liquid aerator as claimed in claim 7 including a threaded adjustment dial configured for controlling movement of the valve body relative to the valve seat between at least a closed configuration in which airflow through the annular airflow passage is blocked, and, an opened configuration in which airflow through the annular airflow passage is maximized.

13. A throttle valve assembly for a liquid aerator, the throttle valve assembly including a valve body movable relative to a valve seat so as to control and regulate air flow therebetween, wherein the valve body includes an occlusion surface and the valve seat includes a seating surface which define an annular airflow passage therebetween, whereby:
(i) upon movement of the valve body towards the valve seat, the annular airflow passage is reduced in area so as to reduce airflow; and
(ii) a centroid of the annular airflow passage remains coaxial with a longitudinal axis in a direction of the movement of the valve body towards the valve seat.

14. A throttle assembly as claimed in claim 13 wherein the occlusion surface and the seating surface are annular about the longitudinal axis and are inclined radially outwardly in a direction from the valve seat towards the valve body.

15. A throttle assembly as claimed in claim 13 wherein the valve body includes a conical configuration.

16. A throttle assembly as claimed in claim 13 including a threaded adjustment dial configured for controlling movement of the valve body relative to the valve seat between at least a closed configuration in which airflow through the annular airflow passage is blocked, and, an opened configuration in which airflow through the annular airflow passage is maximized.

17. A beverage pourer for pouring a beverage from a bottle, the beverage pourer including:
a hollow pourer body having an opening disposed at a first end and a spout at a second end, the hollow pourer body including a liquid pour conduit and an air intake conduit extending therethrough, and an air feed conduit configured for providing air communication from the air intake conduit towards the liquid pour conduit;
the liquid pour conduit having a first end positioned adjacent the first end of the hollow pourer body which is configured for positioning inside of the opening of the bottle, and, a second end of the liquid pour conduit being positioned adjacent the spout so as to allow the beverage in the bottle to be poured out of the bottle via the liquid pour conduit and spout;
the air intake conduit having a first end positioned adjacent the first end of the hollow pourer body which is configured for positioning inside of the opening of the bottle, and, a second end of the air intake conduit being configured for positioning to allow air from outside of the bottle to flow into the bottle via the air intake conduit in response to the beverage being poured out of the bottle via the liquid pour conduit;
the liquid pour conduit including an internal shape configuration adapted for generating a first pressure condition therein as the beverage flows therethrough wherein air in the adjoining air feed conduit is able to be drawn in to the liquid pour conduit in response to the first pressure condition generated in the liquid pour conduit, and, the air intake conduit including an internal shape configuration adapted for generating a second pressure condition therein as the air flows therethrough wherein air in the air intake conduit is able to be forced in to the adjoining air feed conduit in response to the second pressure condition generated in the air intake conduit, whereby at least a volume of air flowing through the air intake conduit is able to be transferred via the air feed conduit in to contact with the beverage flowing through the liquid pour conduit to aerate the beverage.

18. A beverage pourer as claimed in claim 17 including an attachment member for releasably attaching the beverage pourer to the bottle.

19. A beverage pourer as claimed in claim 18 wherein the attachment member includes a collar configured for releasable attachment around a neck of the bottle having the opening disposed thereon, whereby when attached, the first end of the liquid pour conduit is positioned inside of the bottle opening and the second end of the liquid pour conduit is positioned outside of the bottle opening adjacent the spout, and, the first end of the air intake conduit is positioned inside of the bottle opening and the second end of the air intake conduit is positioned outside of the bottle.

20. A beverage pourer as claimed in claim 17 including an occlusion device for regulating flow of air along the air feed conduit from the air intake conduit towards the liquid pour conduit.

21. A beverage pourer as claimed in claim 20 wherein the occlusion device includes a throttle valve assembly.

22. A beverage pourer as claimed in claim 21 wherein the throttle valve assembly includes a valve body movable relative to a valve seat so as to control and regulate air flow therebetween, wherein the valve body includes an occlusion surface and the valve seat includes a seating surface which define an annular airflow passage therebetween, whereby:
(i) upon movement of the valve body towards the valve seat, the annular airflow passage is reduced in area so as to reduce airflow; and
(ii) a centroid of the annular airflow passage remains coaxial with a longitudinal axis in a direction of the movement of the valve body towards the valve seat.

23. A beverage pourer as claimed in claim 20 wherein the occlusion surface and the seating surface are annular about the longitudinal axis and are inclined radially outwardly in a direction from the valve seat towards the valve body.

24. A beverage pourer as claimed in claim 20 wherein the valve body includes a conical-shaped configuration.

25. A beverage pourer as claimed in claim 20 including a threaded adjustment dial configured for controlling movement of the valve body relative to the valve seat between at least a closed configuration in which airflow through the annular airflow passage is blocked, and, an opened configuration in which airflow through the annular airflow passage is maximized.

26. A liquid aerator as claimed in claim 7, wherein the occlusion device includes a depressible wall member disposed in a wall of the pourer, wherein the depressible wall member is positionable between an undepressed position in which air is able to flow into the liquid pour conduit from the air intake conduit via an air feed conduit, and a depressed position in which the wall member occludes an opening of the air feed conduit whereby air is not able to flow into the liquid pour conduit from the air intake conduit via the air feed conduit.

27. A liquid aerator as claimed in claim 26 wherein the depressible wall member includes an elastically deformable material.

28. A liquid aerator as claimed in claim 1 including a constricted region disposed along the second conduit between the first end of the second conduit and a region in the second conduit in which the second pressure condition is generated, whereby the presence of the said constricted region is configured to increase the second pressure in the second region of the of the second conduit during pouring of a liquid from the beverage pourer.
